(19) United States
(12) Patent Application Publication
(10) Pub. No.: US 2016/0133150 A1
(43) Pub. Date: May 12, 2016

(54) Pedagogically integrated method for teaching enhanced reading skills by computer-aided and web-based instruction

(71) Applicant: Richard K. Sutz, Scottsdale, AZ (US)

(72) Inventor: Richard K. Sutz, Scottsdale, AZ (US)

(21) Appl. No.: 13/986,169

(22) Filed: Apr. 8, 2013

Related U.S. Application Data
(63) Continuation-in-part of application No. 12/386,263, filed on Apr. 15, 2009, now abandoned.
Application No. 12/386,263 is a continuation-in-part of application No. 11/267,016, filed on Nov. 3, 2005, now abandoned.
(60) Provisional application No. 60/625,011, filed on Nov. 3, 2004.

(51) Int. Cl. G09B 17/00; G09B 5/02; G09B 17/04

(52) U.S. Cl. CPC G09B 17/003; G09B 17/04; G09B 5/02

(57) ABSTRACT

A system to improve reading skills in preparation for taking a standardized test, comprises a system to identify the most frequently utilized prime words in a language, a house, a computer mounted in the housing, a display operatively associated with the computer, and a computer program product in a storage medium readable by the computer. The product comprises program code for preparatory reading exercise shown on the display and utilizing vocabulary including selected ones of the most frequently utilized prime words, and displaying on the display the most frequently used prime words in formats requiring reading two or more of the most frequently used prime words simultaneously in a single eye fixation.

This patent application is a continuation of U.S. patent application Ser. No. 12/386,263, filed Apr. 15, 2009, which is a continuation of U.S. patent application Ser. No. 11/267,016, filed Nov. 3, 2005, which claims priority on provisional patent application Ser. No. 60/625,011, filed Nov. 3, 2004.

Those of skill in the art have long sought improved apparatus and methodologies to improve reading skills. As used herein, reading skills include comprehension, retention, recall and the speed at which an individual reads.

It would be highly desirable to provide an improved system to improve reading skills.

Therefore, it is a principal object of the invention to provide an improved system to advance reading skills.

This, and other, further and more specific objects and advantages of the invention will be apparent to those skill in the art from the following detailed description, taken in conjunction with the drawings, in which:

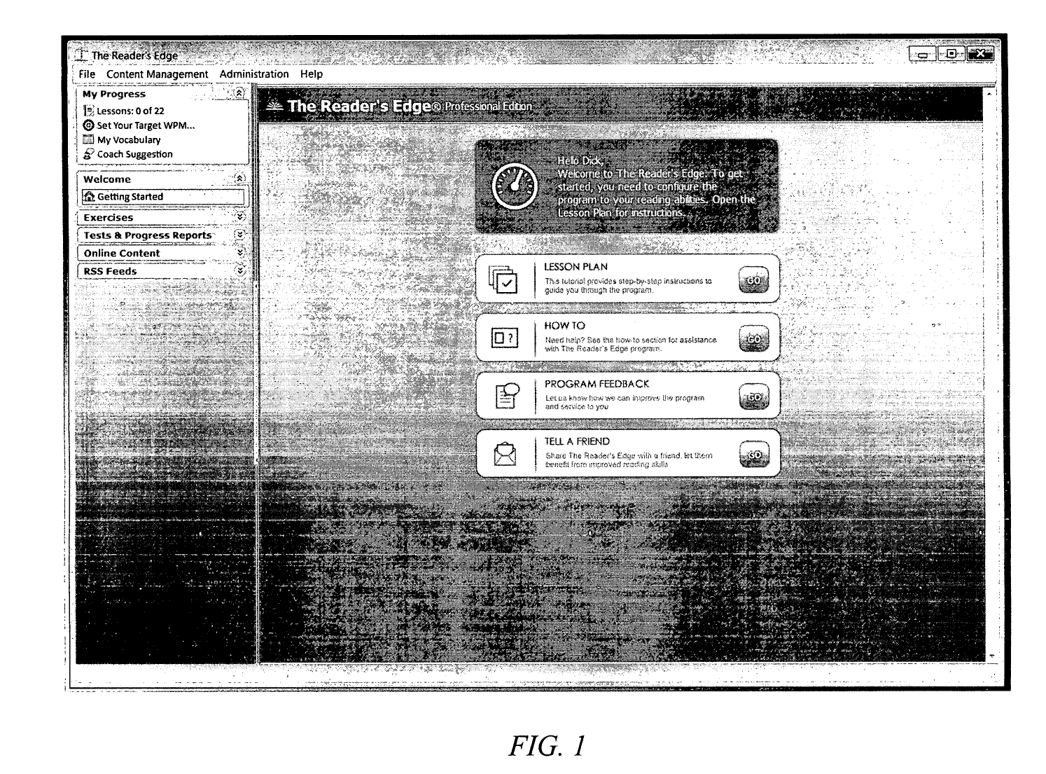

FIG. 1 is an illustration of the opening screen which appears on the display of a computer in accordance with the system of the invention;

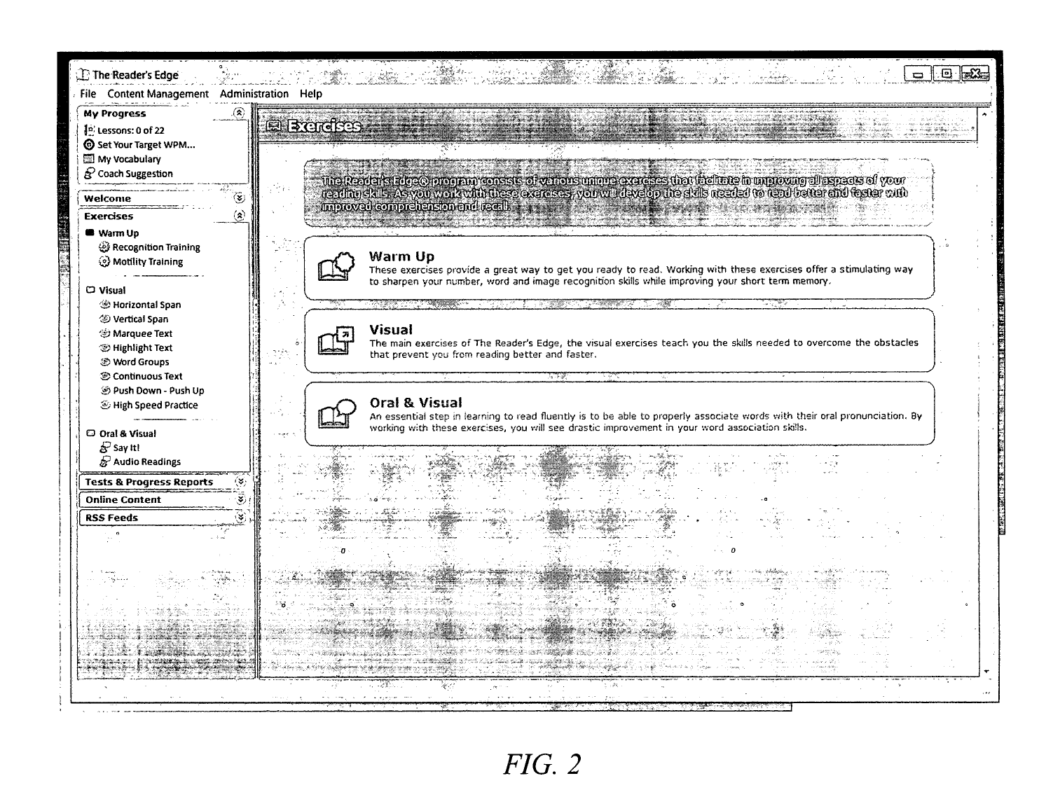

FIG. 2 is an illustration of the screen which appears on the display of a computer when “Exercises” on the opening screen of FIG. 1 is clicked;

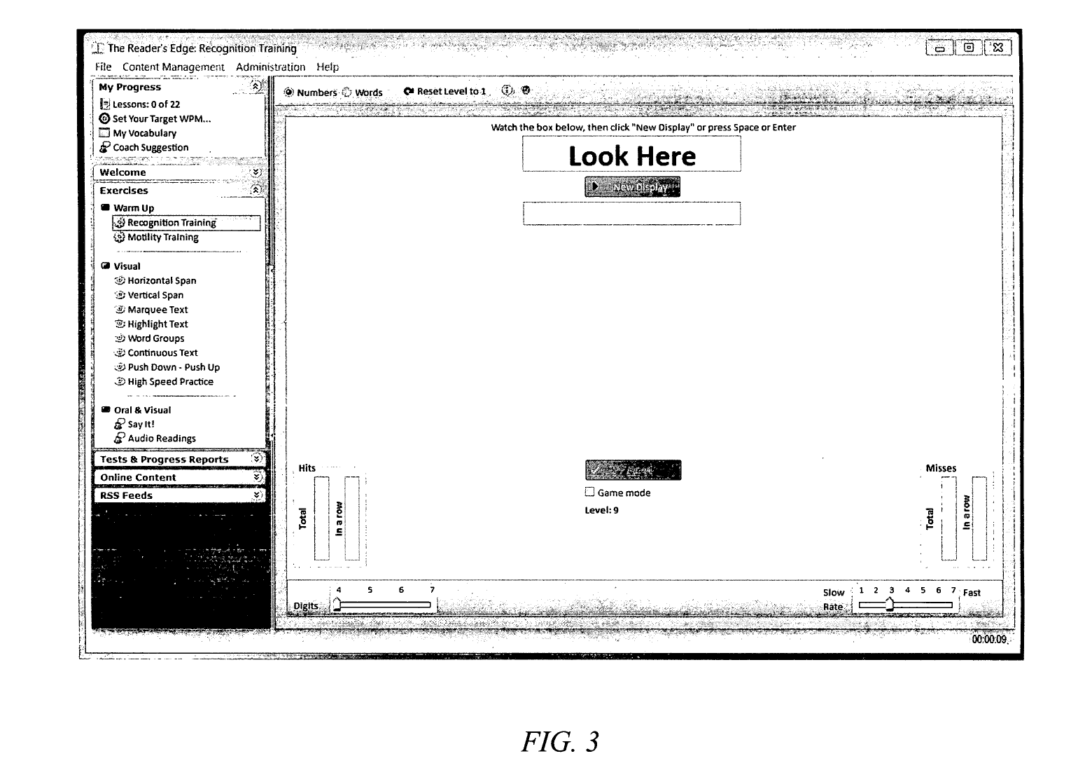

FIG. 3 is an illustration of a screen which appears on the display of a computer during recognition training using the system of the invention;

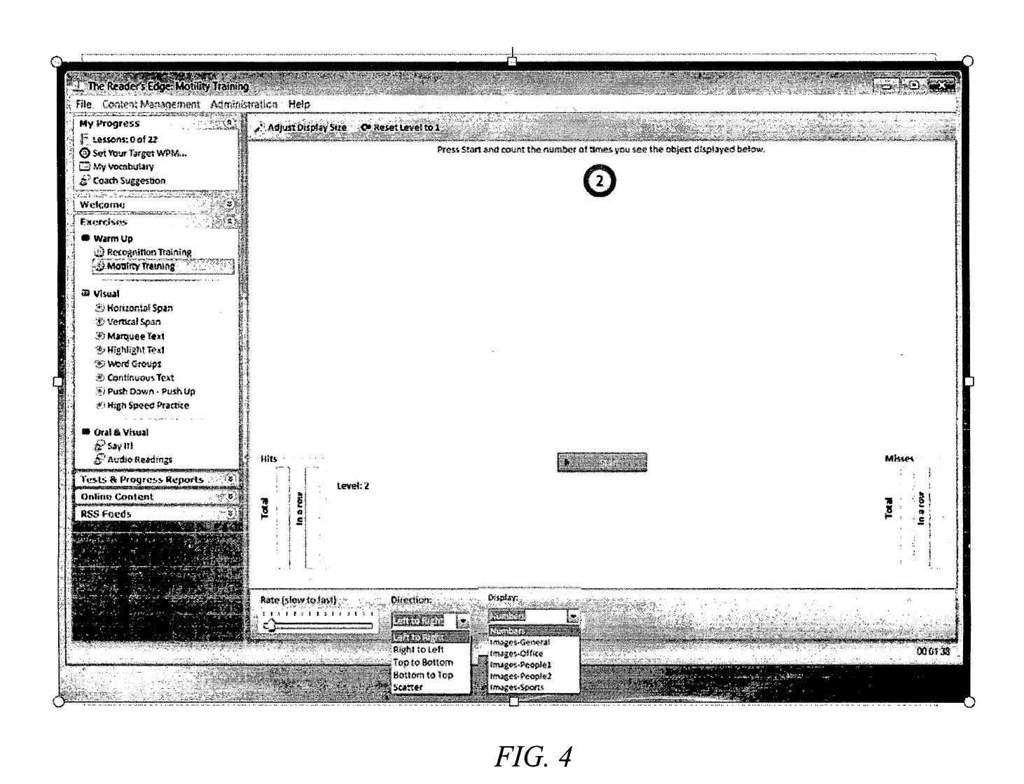

FIG. 4 is an illustration of a screen which appears on the display of a computer during motility training using the system of the invention;

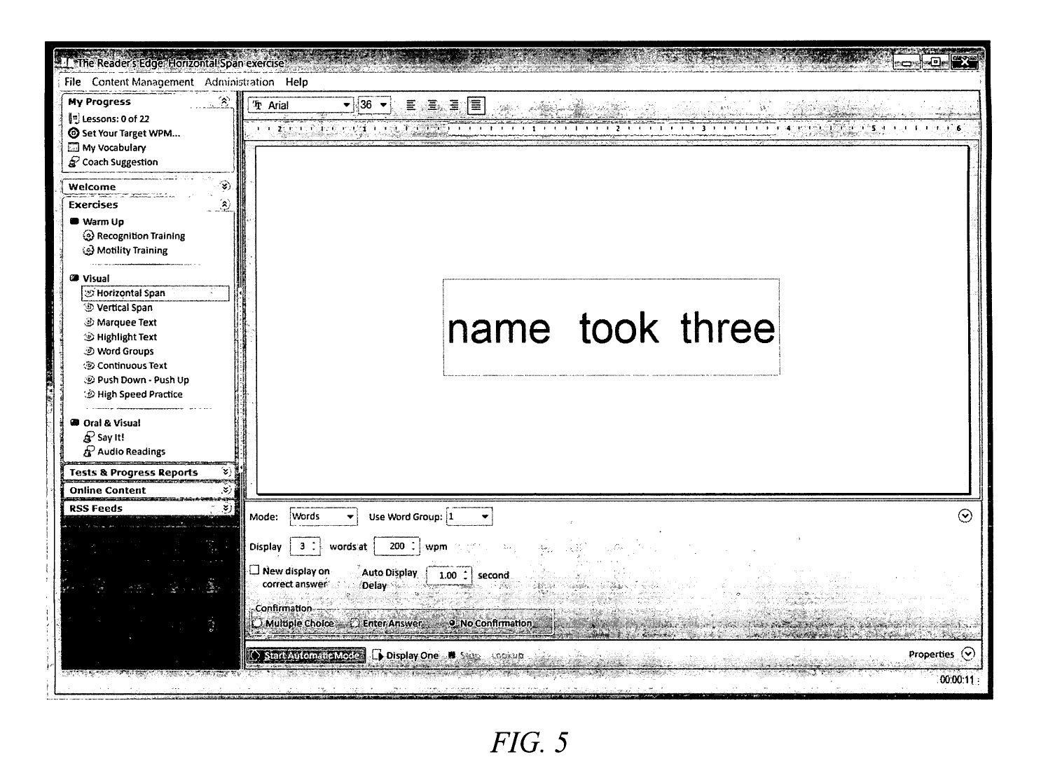

FIG. 5 is an illustration of a screen which appears on the display of a computer during the horizontal span visual exercise using the system of the invention;

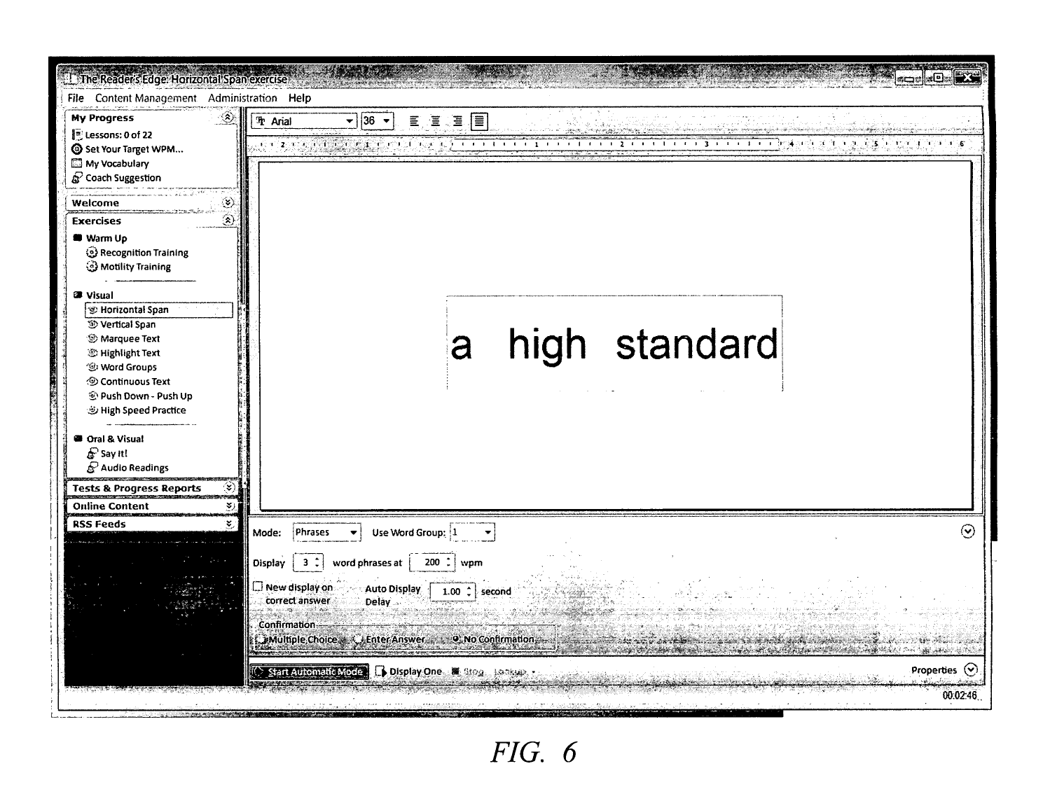

FIG. 6 is an illustration of a screen which appears on the display of a computer during the horizontal span visual exercise using the system of the invention;

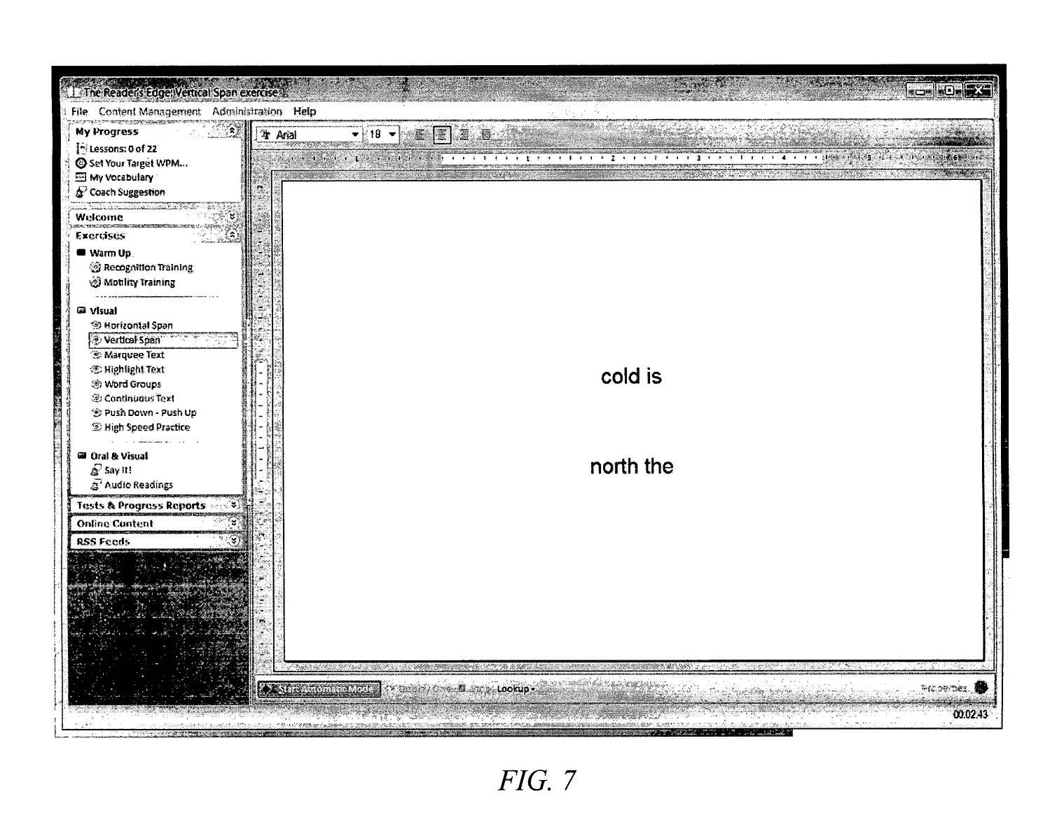

FIG. 7 is an illustration of a screen which appears on the display of a computer during the vertical span visual exercise using the system of the invention;

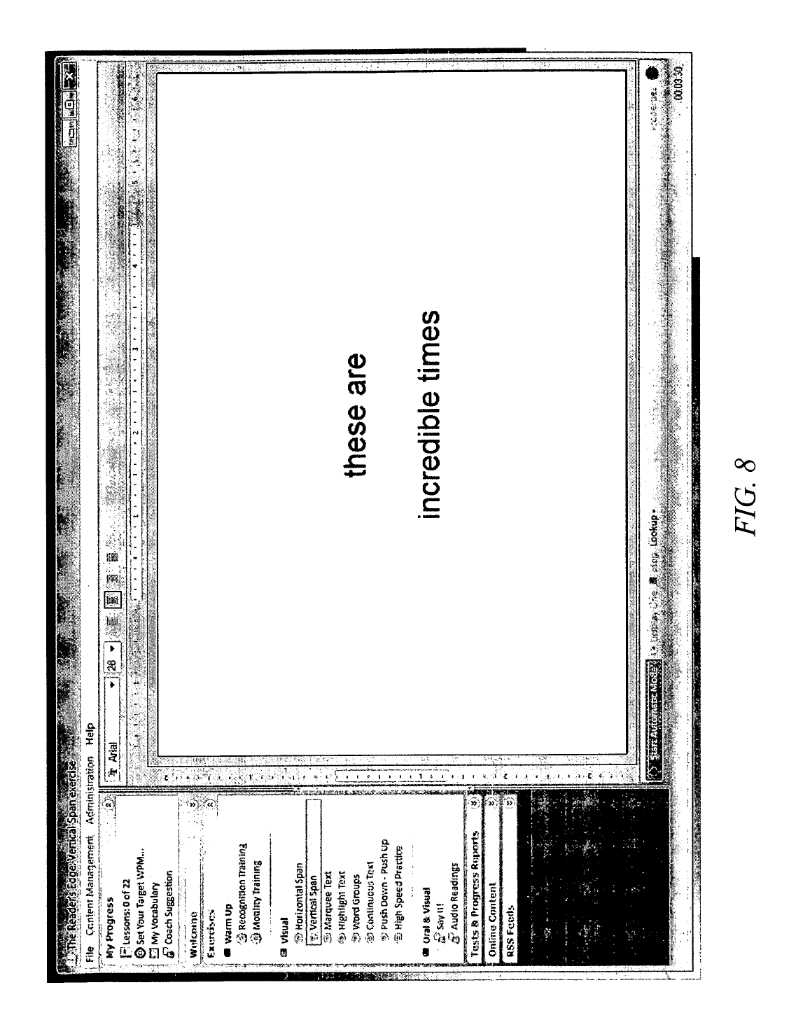

FIG. 8 is an illustration of a screen which appears on the display of a computer during the vertical span visual exercise using the system of the invention;

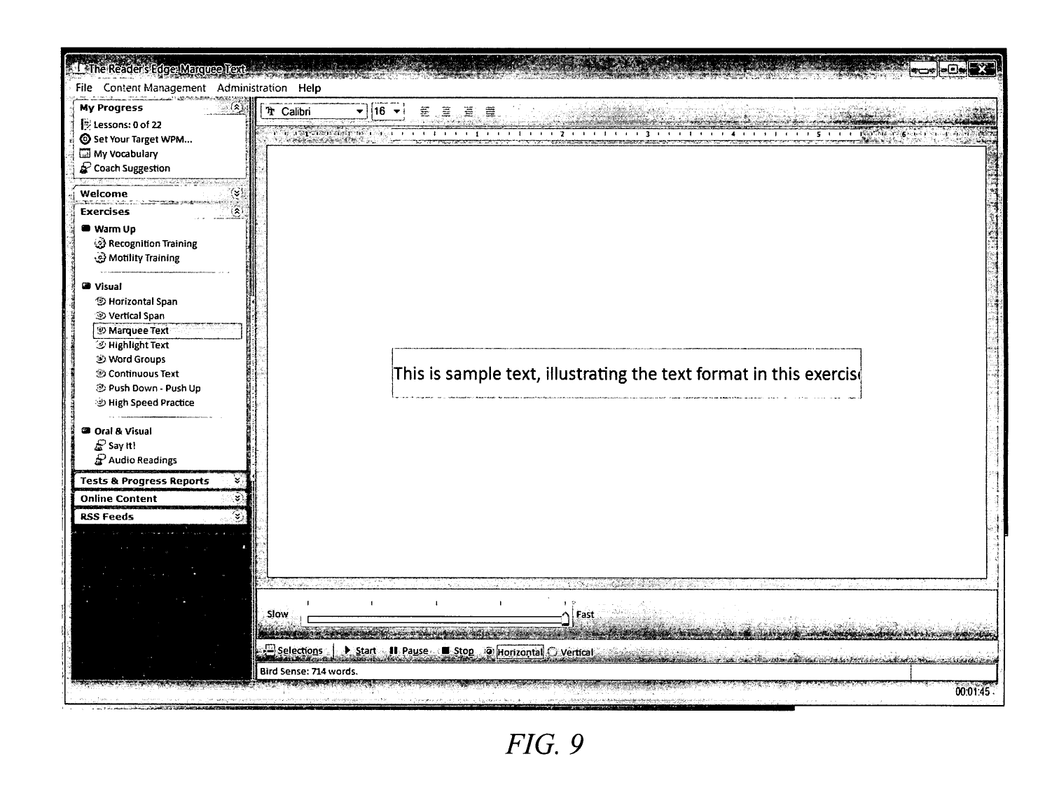

FIG. 9 is an illustration of a screen which appears on the display of a computer during the marquee text exercise using text which scrolls along a horizontal line;

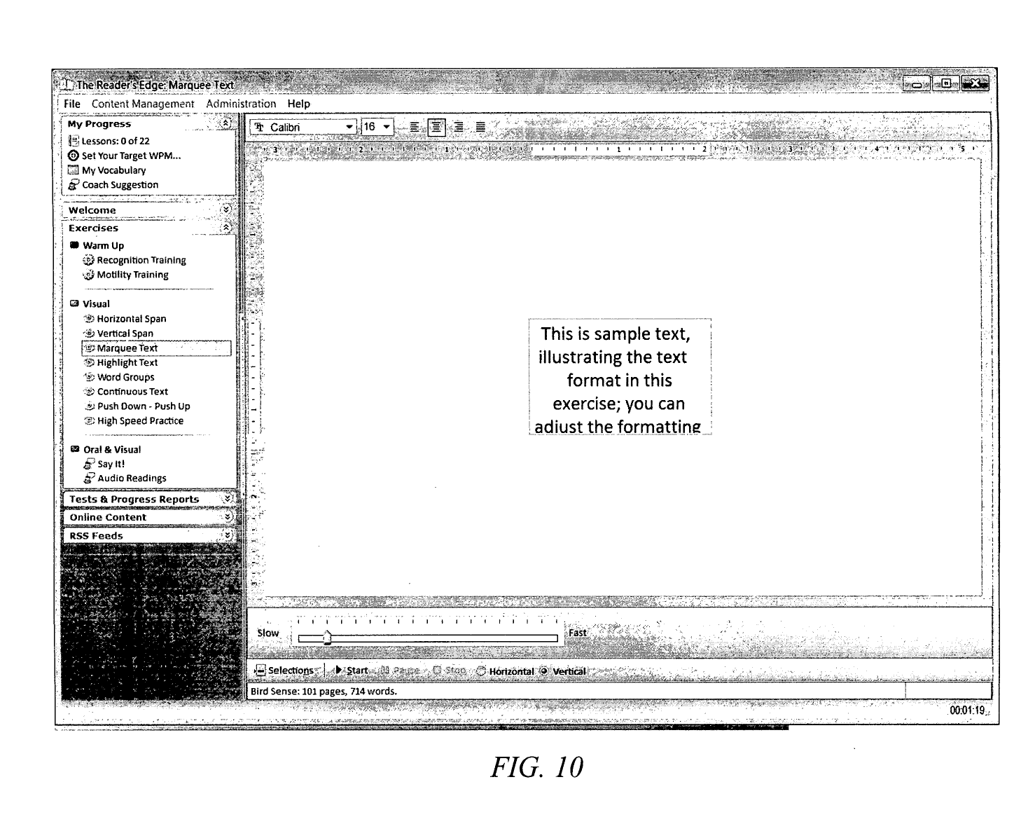

FIG. 10 is an illustration of a screen which appears on the display of a computer during the marquee text exercise using text which scrolls vertically from line to line;

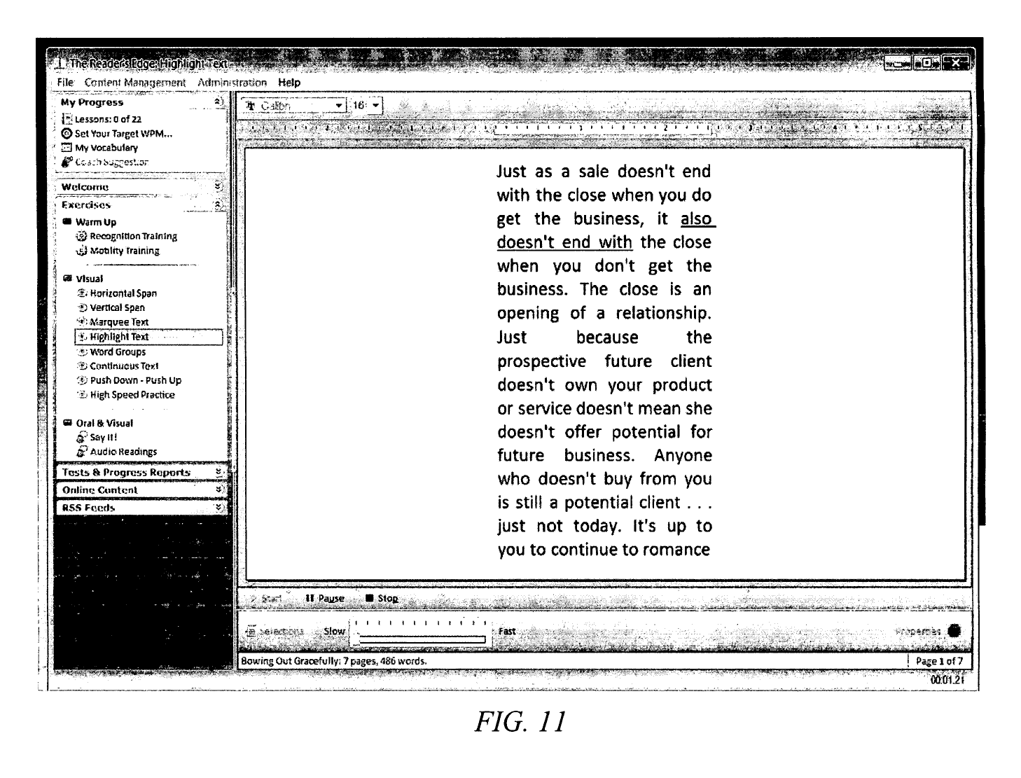

FIG. 11 is an illustration of a screen which appears on the display of a computer during the highlight text visual exercise;

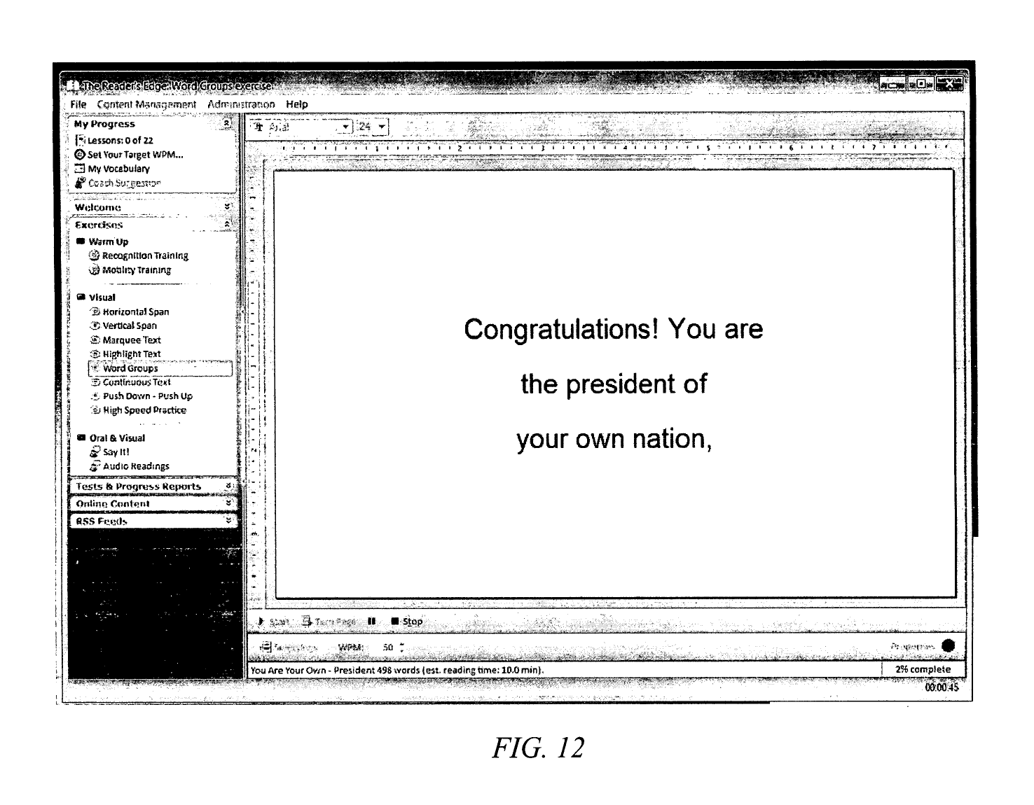

FIG. 12 is an illustration of a screen which appears on the display of a computer during the word group visual exercise;

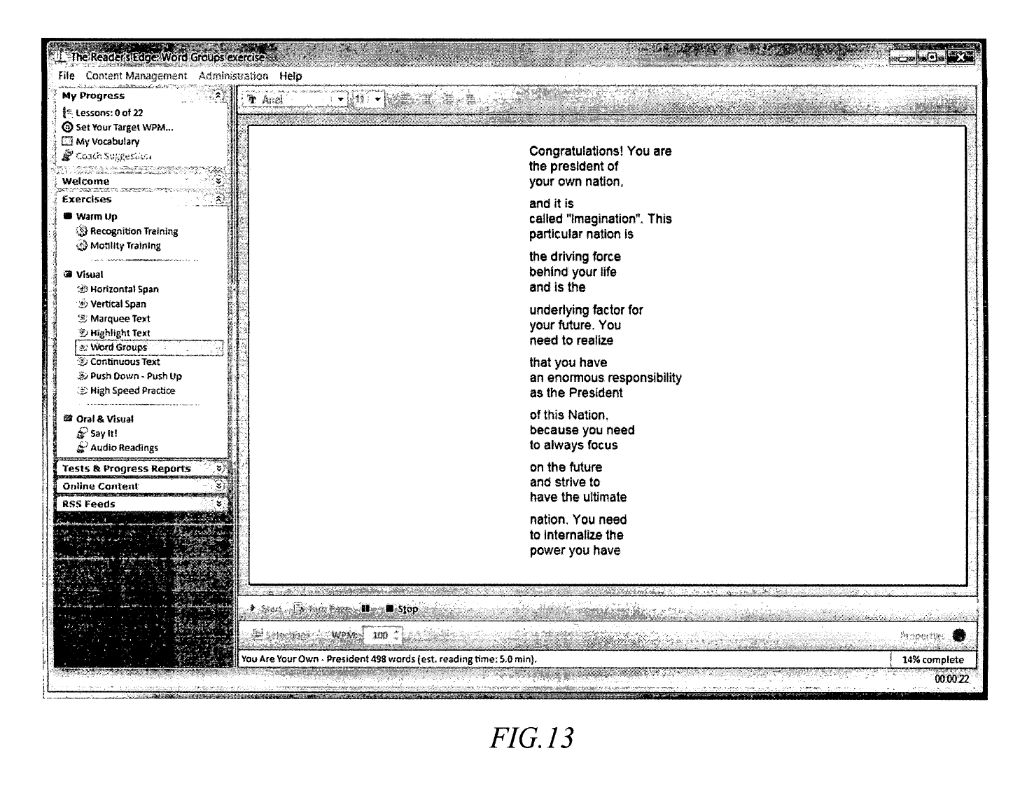

FIG. 13 is an illustration of a screen which appears on the display of a computer during the word group visual exercise;

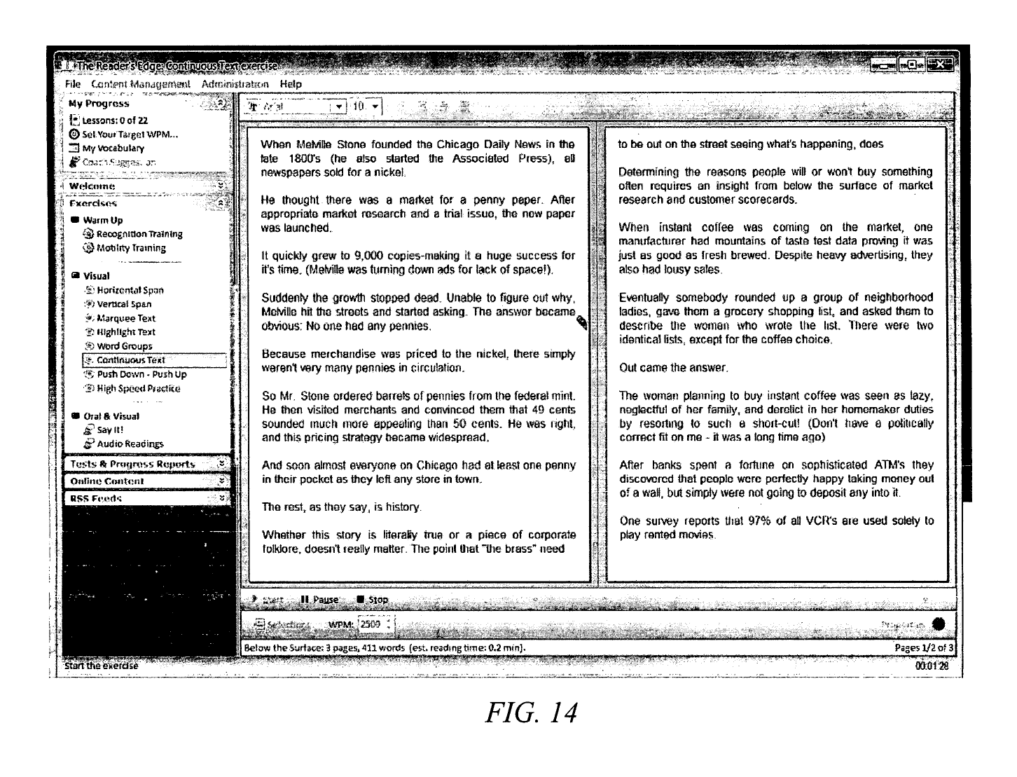

FIG. 14 is an illustration of a screen which appears on the display of a computer during the continuous text visual exercise;

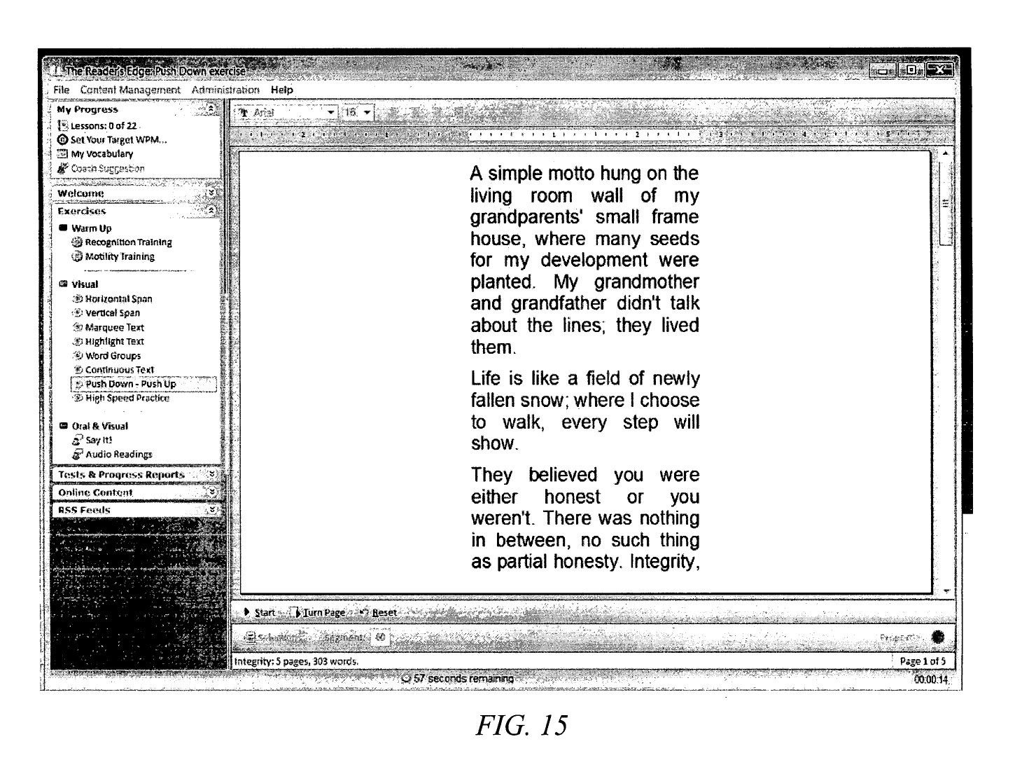

FIG. 15 is an illustration of a screen which appears on the display of a computer during the push down-push up visual exercise;

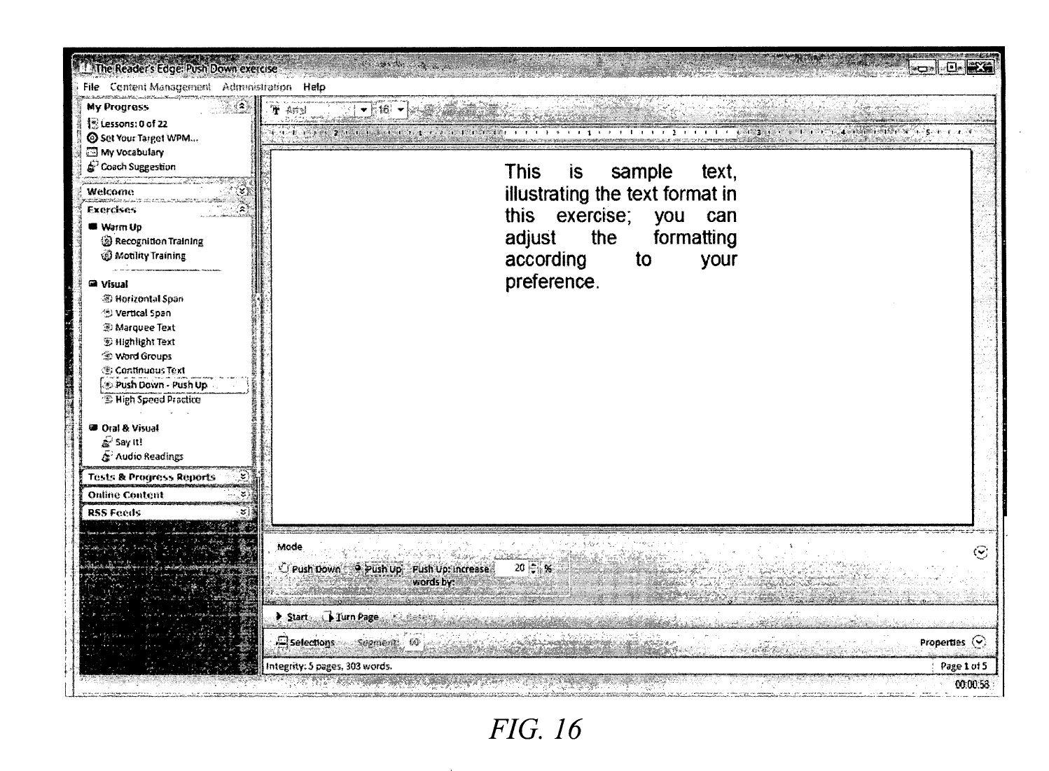

FIG. 16 is an illustration of a screen which appears on the display of a computer during the push down-push up visual exercise;

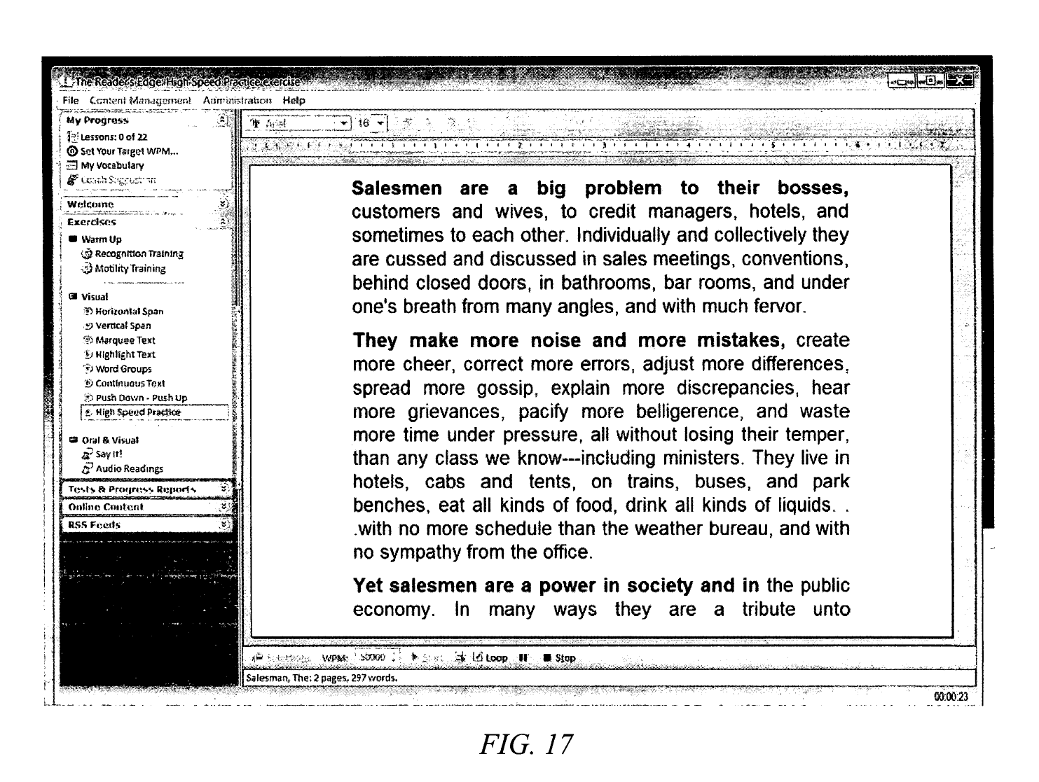

FIG. 17 is an illustration of a screen which appears on the display of a computer during the high speed practice visual exercise;

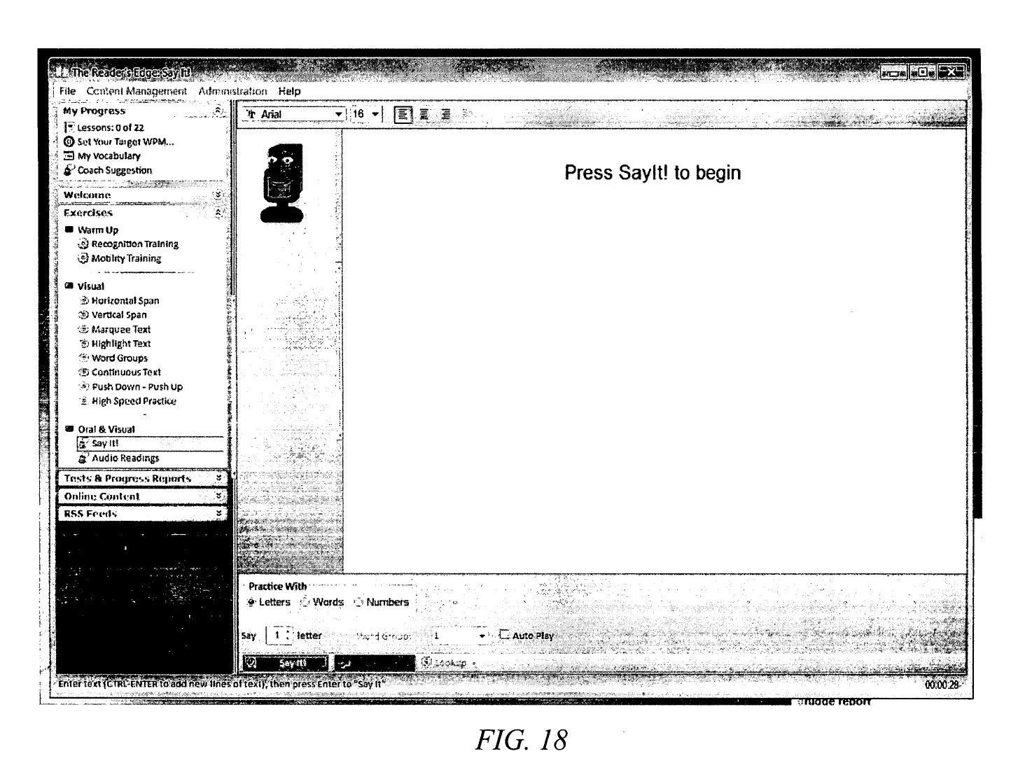

FIG. 18 is an illustration of a screen which appears on the display of a computer during a say it oral & visual exercise;

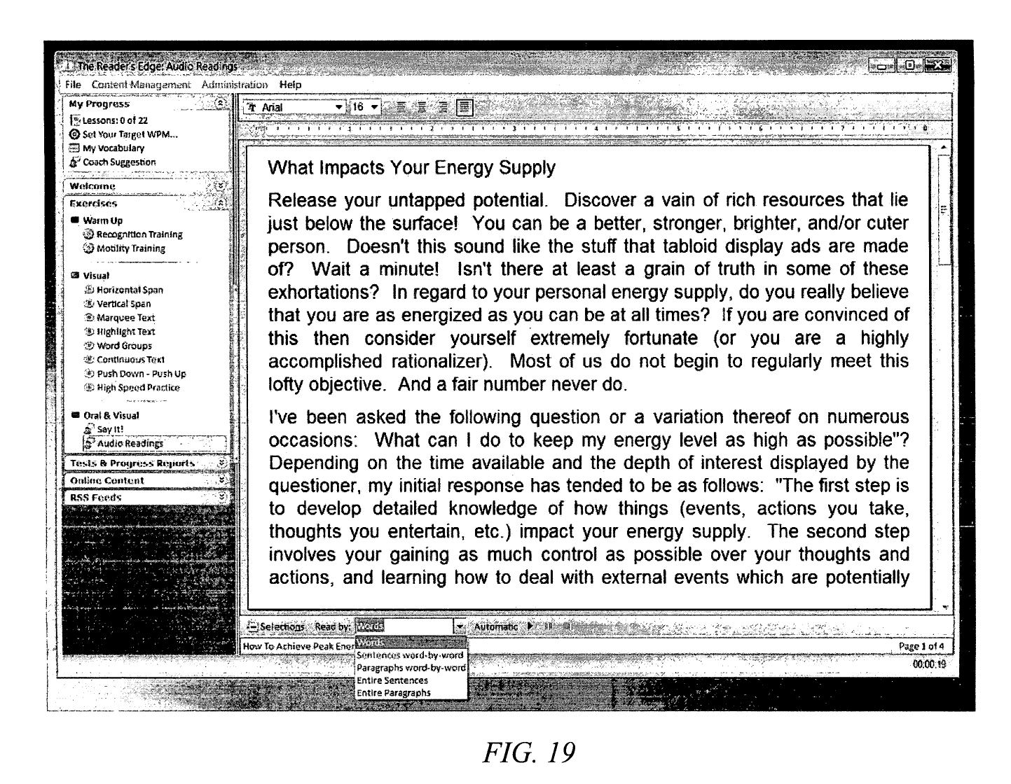

FIG. 19 is an illustration of a screen which appears on the display of a computer during an audio reading oral & visual exercise;

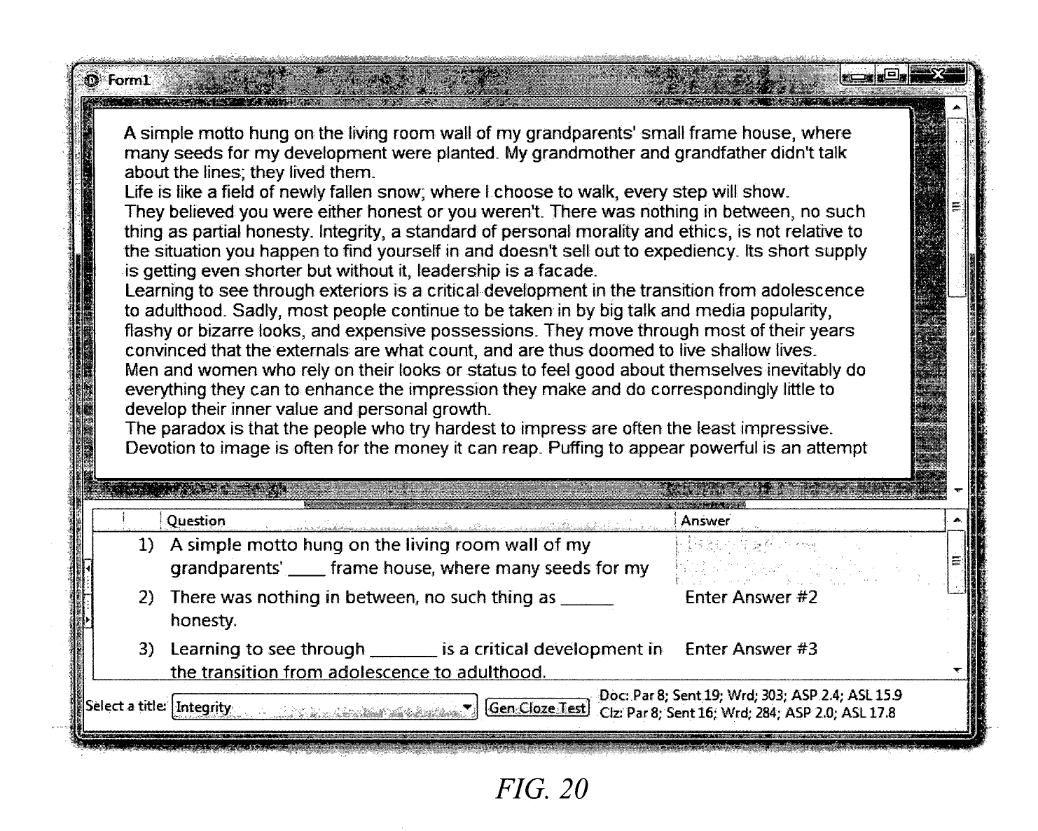

FIG. 20 is an illustration of a screen which appears on the display of a computer during a comprehension test question exercise; and,

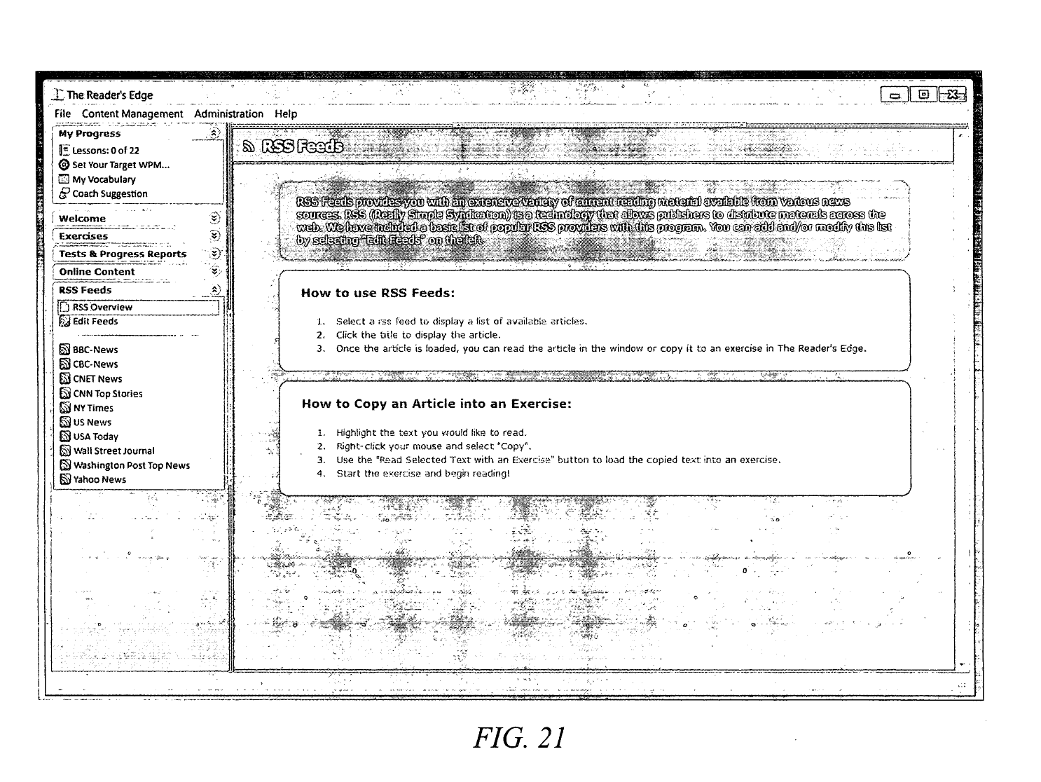

FIG. 21 is an illustration of a screen which appears on the display of a computer during an RSS feed.

Briefly, in accordance with the invention, provided is an improved system to improve reading speed in preparation for taking a standardized test. The system comprises a system to identify words by frequency of use; a system to identify supplemental relevant standardized test-related words; a housing; a computer mounted in the housing; a display operatively associated with the computer; and, a computer program product in a storage medium readable by the computer. The computer program product comprises program code for preparatory reading exercises that is shown on the display and utilizes vocabulary including selected ones of the most frequently used prime words, and selected ones of standardized test-related words each different from each of the selected ones of the most frequently used prime words.

In another embodiment of the invention, provided is an improved system to improve reading speed in preparation for taking a standardized test. The system comprises a system to identify words by frequency of use; a system to identify supplemental relevant standardized test-related words; a housing; a computer mounted in the housing; a display operatively associated with the computer; a computer program product in a storage medium readable by the computer. The computer program product comprises program code for preparatory reading exercises shown on the display. The reading exercises utilize vocabulary including at least 100 of the 2000 most frequently used prime words, and 100 standardized test-related words each different from each of the 100 of the 2000 most frequently used prime words. The reading exercises also display the most frequently used prime words and the standardized test-related words in formats requiring reading two or more words in a single eye fixation.

In a further embodiment of the invention, provided is an improved system to improve the reading speed of an individual in preparation for taking a standardized test. The improved system comprises a system to identify words by frequency of use; a system to identify supplemental relevant standardized test-related words; a housing; a computer mounted in the housing; a display operatively associated with the computer; and, a computer program product in a storage medium readable by the computer. The computer program product comprises program code for preparatory reading exercises shown on the display and utilizing vocabulary including at least 100 of the 2000 most frequently used prime words, and 100 standardized test-related words each different from each of the 100 of the 2000 most frequently used prime words. The reading exercises also display the prime words and the standardized test-related words in formats requiring reading two or more words in a single eye fixation. The reading exercises also include a word grouping exercise in at least one of the “Lines” mode and the “Clumps” mode.

As used herein, a standardized test is an assessment that (1) is intended to measure a test-taker's knowledge, skill, aptitude, physical fitness, or classification in any other topics, and (2) is administered and scored in a consistent manner. Some kinds of standardized tests include college entrance tests (SAT, ACT, LSAT, etc.); high school evaluation tests; tests related to various professions including, for example, medicine, law, real estate, and securities; and, federal, state, and municipal assessment tests.

As used herein, prime words are words that are immediately recognizable by most people, that do not require decoding, and that do not require an eye fixation.

As would be appreciated by those of skill in the art, a word is “immediately recognizable” when an individual is familiar with the word, has seen it before, and recognizes the word. By that standard, most of the words in this patent application are immediately recognizable words.

A word is immediately recognizable by “most people” when the majority of people for whom the language being read is their native language immediately recognize the word. A majority of people immediately recognize a word when 51% or more of the population recognizes the word. Again, by that standard, most of the words in this patent application are immediately recognizable by most people.

Decoding is required when an individual can not assign, and determine, a meaning to a word and when the individual is not certain how to pronounce a word and must use his or her knowledge of letter patterns and of letter-sound relationships to determine how to pronounce a word. A word does not “require decoding” when an individual automatically and instantly assigns a meaning to the word and does not have to determine what the word means, and when the individual immediately and instantly knows how to pronounce the word and does not have to use his or her knowledge to determine how to pronounce the word. By these standards, most of the words in this patent application are words that do not require decoding.

An eye fixation occurs when the eyes, while reading, stop moving. Practically speaking, if the eyes are trying to see a word or something else that is not moving, the only time the eyes can see the word is when the eyes are not moving. That is why a series of eye fixations is what occurs during reading.

The system of the invention requires a analytical system to identify words by frequency of use in written language, i.e., in written publications like books, magazines, Internet articles, newspapers, court decisions, and publications prepared by various businesses. The particular analytical system currently utilized in accordance with the invention uses the books comprising Project Gutenberg as representative of the English written language. Project Gutenberg comprises more than 13,000 public domain books. The entire content of Project Gutenberg was analyzed to determine the frequency with which each unique word appeared in the 13,000+ public domain books. Tables I, II, and III below summarizes the results of this analysis.

TABLE I
UNIQUE WORDS IN PROJECT GUTENBERG

| | Number of | % of 548 |
|---|---|---|
| Total of Words Ranked | Unique Words** | million+ words |
| 548,432,719 | 10 | 20 |
| | 15 | 25 |
| | 121 | 50 |
| | 907 | 70 |
| | 1,599 | 75 |
| | 2,792 | 80 |
| | 5,127 | 85 |
| | 10,000 | 90 |

**Total number of unique words: 2,819,558

A unique word is a word that is spelled differently than any other word.

TABLE II
15 MOST FREQUENTLY USED WORDS
IN PROJECT GUTENBERG

| | % OF | | |
|---|---|---|---|
| | 548,432,719 | | |
| | MILLION | | |
| RANK | WORDS | TOP 15 WORDS | NO. OF TIMES USED |
| 1 | 5.46 | the | 29,970,779 |
| 2 | 2.99 | of | 16,415,645 |
| 3 | 2.92 | and | 15,987,903 |
| 4 | 2.44 | to | 13,383,303 |
| 5 | 2.18 | a | 11,944,901 |
| 6 | 1.55 | in | 8,526,190 |
| 7 | 1.42 | I | 7,796,388 |
| 8 | 1.07 | that | 5,892,696 |
| 9 | 1.02 | he | 5,584,737 |
| 10 | 0.96 | was | 5,280,232 |
| 11 | 0.91 | it | 5,013,897 |
| 12 | 0.84 | his | 4,602,552 |
| 13 | 0.71 | with | 3,912,102 |
| 14 | 0.70 | for | 3,817,700 |
| 15 | 0.67 | as | 3,696,006 |
| | 25% | | 141,825,031 |

TABLE III
LIST OF THE 2,003 MOST FREQUENTLY
USED WORDS IN PROJECT GUTENBERG*

the; of; and; to; a; I; in; that; he; was; it; his; with; for; as; you; is; had; not; but; her; at;
be; on; by; this; which; she; have; him; from; or; my; all; they; me; so; were; we; one;
are; an; if; no; their; said; there; who; would; them; when; will; been; what; out; more;
your; do; then; up; man; now; into; could; our; any; some; other; has; time; than; very;
about; upon; only; like; may; its; did; little; see; these; us; should; made; such; can;
before; great; after; two; know; well; how; over; good; must; first; much;
come [100];
down; where; never; men; old; shall; day; Mr.; those; here; himself; most; own; go; am;
life; came; even; say; without; way; long; again; might; make; through; being; too; new;
many; every; think; back; yet; people; still; take; last; went; away; just; while; thought;
hand; under; die; eyes; same; get; nothing; house; young; give; place; though; also; let;
found; don't; once; ever; things; face; against; name; another; world; right; years; love;
left; work; three; god; project; head; tell; off; sir; king; saw; took; always; put; night; each;
why; lord; look; heart; because; whom; part; father; mind; thing; Mrs.; done; got;
seemed [200];
among; between; far; having; looked; both; small; few; home; better; heard; days; end;
something; going; told; yes; find; seen; called; whole; woman; knew; asked; moment;
country; words; son; word; enough; side; soon; general; since; however; hands; want;
set; room; lady; gave; till; whose; thus; war; other; door; myself; poor; ooh; next; thy;
money; course; quite; perhaps; morning; death; light; brought; almost; does; voice;
turned; water; cannot; state; dear; rather; felt; best; friend; given; taken; began; den;
wife; full; others; power; present; hundred; kind; round; within; true; anything;
themselves; stood; less; year; order; used; herself; indeed; form; public; together; half;
until [300];
it's; white; matter; read; letter; often; nature; states; keep; sent; use; believe; times;
certain; case; high; person; large; already; alone; children; gone; miss; passed; above;
sure; land; hear; received; city; during; span; near; speak; hour; feet; leave; girl; hope;
therefore; air; wish; point; least; says; open; thousand; whether; child; return; along;
women; friends; means; either; answered; cried; known; I'm; rest; dead; four; fact; fire;
free; body; lay; itself; business; English; lost; behind; met; number; call; family; several;
manner; looking; class; second; help; replied; sat; style; held; reason; soul; towards;
boy; five; chapter; truth; please; book; coming; ask; feel; answer;
become [400];
evening; church; earth; question; care ten; really; law; town; sea; black; became; fell;
mean; England; kept; human; need; ground; fear; making; strong; short; I'll;
government; doubt; bed; arms; understand; live; brother; sort; suddenly; cause; start;
river; everything; spirit; bring; age; turn; returned; character; sometimes; possible; hold;
master; rose; able; table; art; dark; around; hard; talk; followed; beautiful; either; prince;
can't ready; none; sight; different; that's; sense; seems; show; saying; close; French;
army; fine; captain; party; following; spoke; subject; common; longer; hours; forth; else;
court; note; blue; story; written; happy; strange; interest; eye; idea; force; blood; early;
later; account; ought;
stand [500];
daughter; mine; suppose; line; added; peace; past; letters; continued; feeling; appeared;
although; remember; across; act; pretty; company; sun; road; history; taking; fair;
certainly; deep; six; carried; mark; necessary; late; service; send; red; change; entered;
pleasure; France; purpose; beyond; husband; sound; cold; forward; further; information;
seem; comes; reached; bad; horse; fal; meet; united; except; office; street; position;
books; pass; heaven; low; toward; real; natural; pay; hair; print; gold; didn't; size; view;
gentleman; living; clear; I've; knowledge; silence; plain; south; opened; below; wanted;
cut; run; fellow; London; miles; yourself; doing; led; copyright; effect; receive; wrong;
van; laid; paid; Paris; tried; desire;
queen [600];
bear; lips; nearly; died; month; arm; window; play; paper; pour; beauty; save; front; glad;
ago; foot; remained; lived; opinion; wind; probably; sleep; big; wild; dinner; future;
according; wrote; smile; strength; whatever; ran; sweet; try; seeing; trouble; chief;
attention; make; secret; society; American; chanced; works; important; thinking; place;
loved; joy; presence; north; walker; duty; rich; reach; faith; he's; hardly; standing; green;
length; date; enemy; happened; instead; write; especially; doctor; march; duke; persons;
youth; sister; there's; greater; immediately; knows; drew; particular; distance; deal;
mouth; object; trees; simple; months; per; noble; tears; stay; hat; besides; thoughts;
minutes; follow; latter; struck; laws; afraid;
twenty [700];
heavy; broken; language; visit; won't; wait; figure; afterwards; single; horses; slowly;
man's; arrived; leaving; stone; various; copy; impossible; married; action; walk; wall;
evil; condition; stopped; moved; filled; beginning; command; learned; silent; goes;
including; hall; author; unless; exclaimed; color; quiet; third; week; danger; expression;
easy; battle; caught; born; places; island; west; worth; beside; scene; ship; statement;
notice; showed; raised; ancient; getting; sit; occasion; uncle; colonel; trying;
conversation; characters; fortune; special; count; foundation; influence; begin; justice;
respect; appearance; giving; wished; literary; usual; grew; domain; carry; waiting; judge;
former; perfect; holy; boys; fight; period; seven; garden; speaking; news; merely; school;
bright; fresh;
expected [800];
prepared; private; enter; field; wonder; started; tone; ladies; due; village; laughed; par;
tree; chair; you're; donations; scarcely; ill; lower; emperor; cry; regard; speech; medium;
lie; reading; property; appear; experience; sudden; royal; presently; lives; fifty; grand;
result; parts; happiness; easily; value; plus; success; marriage; Rome; covered; meant;
quickly; intended; outside; sitting; religion; step; broke; circumstances; remain; grace;
spring; boat; Christian; summer; cast; legal; request; pleased; talking; somewhat;
entirely; beneath; honor; system; piece; fast; eat; soldiers; gentlemen; race; turning;
watch; top; opportunity; generally; laugh; trust; afternoon; charge; food; offered; wood;
produce; matters; walls; million; o'clock; believed; floor; grave; greatest; officers; pain;
allowed [900];
memory; orders; troops; flowers; military; houses; dog; journey; lines; direction; music;
sword; girls; nation; father's; formed; stop; wide; escape; cost; produced; authority;
changed; forget; hill; servant; steps; pale; vain; perfectly; eight; likely; dress; passion;
political; considered; proper; total; terrible; meeting; winter; writing; wise; passing;
personal; sake; pleasant; usually; bit; majesty; straight; middle; pride; offer; east; looks;
fit; soft; picture; difficult; dream; killed; footnote; reply; corner; breath; closed; promise;
sin; break; observed; drawn; courage; sky; allow; thank; otherwise; fixed; rise; dollars;
surprise; understood; affairs; bound; study; release; learn; ways; glass; conduct; drink;
wine; camp; ourselves; silver; declared; simply; pray; questions;
spoken [1000];
worthy; ones; surely; fate; threw; finally; original; leaves; worse; takes; supposed; spite;
president; minute; attempt; liberty; directly; move; hot; instant; names; spot; passage;
list; discovered; fancy; spent; crowd; America; touch; plan; health; yours; determined;
instance; twelve; board; cross; isn't; king's; Christ; complete; considerable; obliged;
glory; ears; loss; safe; required; lead; lying; gives; named; possession; German;
darkness; shot; difficulty; situation; sorry; running; national; file; mountain; existence;
repeated; confidence; fallen; stranger; iron; built; equal; efforts; wouldn't; degree;
damages; mountains; aunt; serious; warm; ordered; you'll; bank; might; train; couldn't;
distribute; remove; choose; heads; promised; knowing; sign; what's; aside; brown;
expense; exactly; century;
wonderful [1100];
religious; higher; honest; carriage; union; express; modern; glance; palace; seat;
example; rights; smiled; foreign; proud; quick; shore; page; official; Europe; taste; main;
sad; path; files; clothes; curious; gate; song; vast; officer; divine; appears; forgotten;
hast; creature; listen; members; shut; finished; golden; progress; sons; meaning;
expect; working; permission; talked; physical; terms; shook; consider; forced; temple;
game; opposite; welcome; valley; gods; lose; neck; anxious; hearts; caused; effort; rock;
advantage; excellent; social; ear; rising; movement; sufficient; I'd; attack; science;
moral; mentioned; broad; pity; marry; felling; shown; Indian; accept; priest; breast;
serve; false; judgment; native; pure; rule; papers; proved; difference; greatly; castle;
guard;
fashion [1200];
minister; engaged; space; support; altogether; holding; lot; watched; decided; servants;
gentle; sought; powers; tongue; rate; title; lies; limited; streets; Washington; thrown;
nobody; forms; bread; dare; ideas; prove; sick; narrow; additional; weeks; blow;
described; enemies; Greek; reader; forest; advance; seek; tall; events; dropped; share;
report; thirty; keeping; cases; clearly; check; bill; nations; building; brave; touched;
remembered; British; bottom; spread; angry; fault; hung; delight; machine; net; daily;
December; box; comfort; freedom; refused; surprised; importance; failed; distant;
provided; ordinary; sides; settled; everybody; pieces; faces; governor; virtue; poet; dry;
shoulders; twice; sharp; stream; birds; kill; agree; moon; Israel; method; hills; waited;
measure; you've;
truly [1300];
interesting; foot; presented; midst; contrary; rain; evidence; fingers; midnight; draw;
supper; quietly; expressed; similar; succeeded; contrary; rain; evidence; fingers;
midnight; draw; supper; quietly; expressed; similar; succeeded; calm; satisfied; grass;
shoulder; August; princess; highest; yellow; species; facts; occupied; handsome;
interested; opening; animal; capital; alive; genius; search; hotel; extent; council; sacred;
accepted; obtained; lake; finding; square; tells; nevertheless; evidently; one's; hearing;
chamber; seized; carefully; liked; aid; stage; naturally; conditions; Jesus; weather; trade;
grant; served; mass; hence; shame; soldier; desired; literature; wealth; yesterday;
points; archive; habit; mistress; thick; tired; possessed; fort; post; spirits; telling; shadow;
unknown; individual; grow; January; peculiar; readers; affection; companion; guess;
windows; copies; she's; July; played; liability; text; Spanish; education;
kingdom [1400];
fully; agreed; saved; walking; crown; animals; bent; dangerous; rank; apparently;
sorrow; imagine; noticed; suffered; devil; gathered; advice; Spain; created; wisdom;
behold; powerful; necessity; particularly; ring; gray; weak; university; slight; listened;
bore; instantly; storm; prevent; mad; waters; fond; affair; concerning; dressed; crossed;
November; growing; drive; noise; cousin; refund; pardon; friendship; ships; birth; loud;
nine; burst; June; thin; willing; laughing; secure; distinguished; population; quarter;
content; station; pointed; taught; mercy; familiar; aware; smiling; grown; fish; wounded;
tender; regarded; legs; throw; empty; famous; professor; ain't; putting; car; sending;
woods; leading; bird; surface; height; previous; edition; explained; price; weight; portion;
heat; beat; bridge; conscience;
faithful [1500];
imagination; possibly; rode; suggested; arrival; season; snow; appointed; address;
message; hurt; whispered; lovely; major; constitution; grief; hopes; suffering; wore;
popular; provide; burning; prayer; joined; absence; suffer; begun; poetry; final;
established; remarked; remains; advanced; breakfast; readable; kings; prison; fly; lifted;
prepare; resolved; receiving; sing; wants; crime; dying; entire; smoke; forty; pounds;
equally; published; mother's; pocket; Indians; coast; extraordinary; October; amount;
frequently; stands; claim; needed; ceased; follows; moving; using; we'll; nice; empire;
flesh; civil; notes; add; watching; upper; farther; disk; clemens; satisfaction; program;
slow; teeth; practice; informed; anger; congress; blind; struggle; knees; consequence;
announcement; remarkable; equivalent; dignity; superior; distributed; terror; bitter;
worked [1600];
approach; calling; employed; interests; busy; bold; cruel; thanks; accompanied;
sympathy; seated; explain; happen; brain; fifteen; occurred; Italy; throughout; Sunday;
marked; inside; impression; stars; take; coat; commanded; fields; driven; praise;
distribution; won; splendid; principle; stones; falling; minds; moments; task; subjects;
material; carrying; kindly; nearer; edge; discover; sum; proposed; pressed; drive;
increased; everywhere; actually; moreover; pair; despair; nose; lover; cities; relief;
separate; secretary; chosen; ride; bishop; maid; admitted; dust; forces; volume;
permitted; apply; firm; shape; principal; knight; group; sacrifice; audience; capable;
completely; quality; wholly; details; rooms; victory; doors; relations; inhabitants; contact;
direct; parties; hate; features; motion; bearing; belief; mention; drawing; deeply;
wasn't [1700];
ended; acquaintance; female; brief; citizens; join; removed; computer; delicate;
understanding; dull; proof; manners; worst; hoped; rapidly; treated; series; strike;
throne; April; absolutely; buy; fruit; regular; doesn't blessed; catch; choice; friendly;
excuse; contain; gained; constantly; saint; innocent; flight; asleep; fighting; excitement;
numerous; thousands; roof; college; reasons; buried; whenever; wear; proceeded;
continue; escaped; drop; voices; self; mistake; plans; principles; ahead; addressed;
sooner; faint; trademark; charming; becomes; double; pope; bow; God's; fall; brilliant;
interrupted; rough; couple; included; huge; member; demanded; consideration; duties;
kindness; policy; kiss; bell; weary; excited; pages; haven't; press; fought; beg; vision;
amongst; intellectual; bare; grey; ease; entrance; clouds; vessel;
stated [1800];
enjoy; sold; unable; ruin; rocks; desert; thinks; association; bought; playing; gain; ages;
curiosity; anybody; abroad; teat; circle; admit; gradually; assured; brothers; event; trial;
intelligence; fellows; bodies; souls; Egypt; returning; central; practical; asking; laughter;
dozen; partly; forgive; delivered; Italian; hidden; gently; concerned; nun; admiration;
level; control; departure; precious; singing; police; awful; rare; wishes; anxiety; clean;
slave; prisoner; safety; plenty; confess; con; custom; prisoners; larger; cover; numbers;
rules; accustomed; intention; useful; solemn; contents; suit; sentence; stories; republic;
smith; cap; relation; favor; apart; doubtless; figures; temper; parents; extreme; labor;
ocean; worship; exercise; recognized; description; approached; eager; lands; bringing;
record; closely;
remark [1900];
replacement; wicked; swift; rendered; surrounded; conscious; kissed; drams; thine; soil;
triumph; pictures; center; harm; learning; exact; pause; rage; warranties; cloud; obtain;
dogs; electronically; frank; gay; library; violent; witness; parliament; islands; Germany;
disappeared; miserable; ball; energy; showing; constant; gift; consent; skin; speed; pen;
assistance; foolish; needs; stairs; likewise; cheeks; shows; division; protection;
arranged; results; related; introduced; devoted; credit; chose; dance; provisions; sprang;
perceived; guide; becoming; addition; younger; connected; countries; objects; emotion;
raise; theory; paused; fled; bosom; indicate; destroyed; win; immense; wound; increase;
base; acts; fill; meanwhile; centre; email; active; process; error; supply; princes; visible;
revolution; composed; fees; southern; fame; dreadful; applied; slept;
eternal [2000];
sand; patient; loose
*The words in Table III are listed in descending order of frequency. For example, “the” is the most frequently used word, “of” is the next most frequently used word, and so on.
Every 100^{th} word is numbered.

The particular system utilized to determine the frequency with which words appear in written documents can vary as desired. A tally can, for example, be made by hand, although this is unlikely due to the time that would be required. The publications chosen can also vary. In view of the great number of words in the Gutenberg Project, it is believed that the frequency word count determined likely is reasonably accurate, with some exceptions likely occurring in view of new present day vocabulary like “Google” and “Bing”. Present day vocabulary can, if desired, be assessed by analyzing publications on the Internet to determine additional frequently used words which do not appear per Project Guttenberg to be frequently utilized. Frequently utilized present day vocabulary can be added to the 1599 words comprising 75% of the Project Gutenberg publications. As indicated by Table I above, approximately 1,599 words from the Gutenberg Collection represent about 75% of all the words one will read in the English language. At any rate, preparing an assessment setting forth frequently used words is an important part of the invention, regardless of the particular model and/or publications used to make such a determination, and regardless of whether the word frequency list which is developed matches exactly with the results noted above with respect to Project Guttenberg. The goal of such an assessment is to identify frequently utilized prime words so that this vocabulary can be incorporated in the system of the invention. The 2,000 most frequently used words are prime words. The next 8,000 most frequently used words (words 2,001 to 10,000) on the frequently used word list are also likely prime words. The 2,000 most frequently used words are prime words simply by virtue of the frequency with which they appear in written language, as are the 5,000 most frequently used words similarly are prime words.

In presently preferred embodiments of the invention, once a word frequency list is generated, unique prime words making up a selected portion of written language—as defined by the word frequency list—are utilized. In one embodiment of the invention, the number of unique words so utilized currently is in the range of 40% to 95% of the words which make up the written language and which are most frequently used in the written language, preferably 50% to 90% of the words which make up the written language and which are most frequently used, more preferably 60% to 85% of the words which make up the written language and which are most frequently used, and most preferably 70 to 80% of the words which make up the written language and which are most frequently used. In another embodiment of the invention, the number of words so utilized is at least 100 of the 2000 most frequently used words in the written language, preferably at least 250 of the 2000 most frequently used words in the written language, more preferably at least 500 of the 2000 most frequently used words in the written language, and most preferably at least 1000 of the 2000 most frequently used words in the written language.

In the presently preferred embodiment of the invention the words making up about 75% of written language are utilized. This group of words consists of the 1599 prime words is set forth in Tables I and III as comprising 75% of the written language in Project Guttenberg. Added to this group of words making up 75% of written language is an additional group of supplemental relevant standardized test-related prime words, which typically number in the range of 300 to 500 words, although this to can vary and preferably comprises a group of at least 100 prime words. The supplemental relevant standardized test-related words can, for example, comprise prime words from a list of vocabulary words which are recommended for a test taker to know. It is a common practice for the organization giving a standardized test to provide such a list. Such a list is, for example, provided in conjunction with SAT tests and many other, if not most or all, standardized tests. Or, the supplemental relevant standardized test-related words can, for example, comprise a list of vocabulary words commonly associated with a particular vocation (e.g., metallurgical engineer, bus driver, accountant, pilot, etc.) or other subject (biology, archery, gardening, etc.). In the event the company giving a standardized test does not provide a list of recommended supplemental relevant standardized test-related words, any method can be utilized to generate a list of supplemental relevant standardized test-related prime words. Lists of vocabulary words associated with particular vocations are common. In accordance with the invention, supplemental relevant standardized test-related words are not found in the earlier noted list of prime words representing about 75% of the written language.

In one embodiment of the invention, the supplemental relevant standardized test-related words need not be prime words, or may only consist in part of prime words.

When the supplemental relevant standardized test-related prime words are combined with the words representing about 75% of the prime words used in written language, a master word list is produced in which approximately 90% of all the words in a particular standardized test are represented. This greatly facilitates teaching efficient reading skills in preparation for the standardized test. The master word list typically includes about 2000 prime words. The master word list can, as noted, include a greater or lesser number of words than 2000 words. However, as the number of words utilized increases beyond 2000 words, the length of reading exercises required begins to become more burdensome. And, psychologically, informing a student that he will be learning about 2000 words is more appealing than suggesting a greater number of words is required. Finally, knowledge of 90% of what is being read ordinarily enables an individual to read with reasonable comprehension.

Once a master word list for a particular standardized test is produced, reading exercises are developed and incorporated into a computer program. The reading exercises utilize words from the master list, as well as other words. The computer program is embodied in program code and stored on a medium readable by a computer. For example, the medium can comprise a CD, computer punch cards, or any other medium readable by a computer. The reading exercises preferably, although not necessarily, concern subject matter of interest to an individual using the computer program. Using subject matter of interest to the individual using the computer program can be particularly important in providing motivation for the individual to read the material.

One feature of the reading exercises is that they utilize prime words from the master list to produce phrases that are two to eight words long. The program can display each phrase for a period of time selected by the user, and the user can also select the number of words utilized in each phrase. When the user views the phrase he is to read, if possible, the phrase with a single eye fixation, instead of reading the phrase word by word and moving the eyes from word to word. An eye fixation occurs when the eyes are not moving and the user is looking at a specific point on a page or computer screen. The user begins with two word phrases, then advances to three word phrases, four words phrases etc. up to phrases eight words long. The object is to learn to view each phrase with a single eye fixation, or with at least fewer eye fixations than the number of words in the phrase.

During a first “Horizontal Exercise”, prime words appear along a horizontal line in random order. As used herein, when words appear in random order they do not appear as a phrase, i.e., the words do not form a sense unit. For example, the following words appear in random order and do not form a sense unit:
BONE THE A WHITE ATE DOG

A user is asked to say the random words out loud while they are visible on a display screen. The user is not able to verbalize the words at a rate any faster than about 160 to 220 WPM

In the second “Horizontal Exercise”, prime words appear on the screen along a line as a phrase. For example, the following words comprise a phrase and form a sense unit:
THE DOG ATE A WHITE BONE
   The user is then asked to read the phrase aloud after the image has left the screen. The user can say the phrase more quickly than was the case with the random words.

The use of the second “Horizontal Exercise” in which prime words are presented in phrases is an important feature of the invention because it encourages a user to read two or more words during each eye fixation. The user begins with phrases comprising two words and increases, preferably gradually, the number of words in a phrase until phrases containing a selected number of words are reached. The use of prime words in both the first and second “Horizontal Exercises” is critical because a student need not concern himself or herself with recognizing or decoding a primary word and because prime words do not each require an individual eye fixation while reading; an individual can read simultaneously two or more prime words during a single eye fixation.

If the user wishes, after a phrase appears for a selected period of time and then disappears, the user can take a multiple choice test to see if the user saw and remembers the entire phrase. Importantly, the user controls, as noted, the number of words in the phrase to be displayed, determines the length of time that the phrase is visible on a computer display screen, and determines whether he or she wishes to take the multiple choice test.

As used herein, a phrase comprises a group of two or more words that form a sense unit expressing a thought. The sense unit can be expresses fragmentarily with a complete predication, as in “Good for you!” The sense unit or thought can be with a weakened form of predication, as in “God willing”. The sense unit can be expressed as a sentence element not containing a predication but having the force of a single part of speech, as in “could have been found”. The sense unit can be expressed as a sentence element having a modifying relation, as in “faithful dog”. The sense unit can be expressed as a sentence element having a coordinate or multiple relation, as in “dogs and cats”. The sense unit can be expressed as a sentence element having a composite relationship as in “might have been found”. The sense unit can be expressed as a sentence having a subject and verb as in “The horse ate hay.”

Another feature of the computer program is that a table of contents or navigation flow chart can be continuously displayed on a portion of the display screen so that a user can at all times see where he or she is in the program.

People learn visually, orally and kinesthetically. The computer program of the invention permits a user to employ any of these three approaches. The program has a feedback mechanism comprising a genie or other character that, when the user selects the genie, talks to the user and delivers messages and/or feedback to a user. The user can disable the genie at any time. The continuously visible table of contents provides visual input. The use of multiple choice questions provides kinesthetic feedback by validating that the user saw what he or she thought he or she read on the computer screen. When the program gives the user a multiple choice question to determine if the user read an entire phrase, if the user gets it wrong, the user gets another chance. This unique feature of the invention demonstrates that the invention preferably focuses on teaching, rather than testing. The invention is user controlled, rather than comprising a program which automatically increases reading speed when a user has a correct answer and which marks an error does not increase reading speed in the event a wrong answer is provided. If the user gets the question wrong a second time, the computer program gives the correct answer because the computer program “teaches” and does not test. The computer keeps track of the number of correct answers and at selected times feeds this information kinesthetically back to the user. The user can, if desired, disable the test questions so that the user does not have to view or answer such questions.

The dimensions of a window on the display screen is adjustable. Words, phrases or sentences are displayed in the window. The user can, for example, elongate the window (or elongate the spacing between words) to spread out words and to exercise the peripheral vision used by an user when he or she is attempting to read words or phrases or sentences.

The reading exercises provided in the computer program are arranged in a suggested sequential order. The first recommended exercise is the first “Horizontal Exercise” set forth above. The second recommended exercise is the second “Horizontal Exercise”, also set forth above. One purpose of these exercises is to demonstrate to a user that the user can read three to five times faster if the user doesn't speak the words while reading the words. Each of the exercises following the first and second “Horizontal Exercises” uses complete reading selections, e.g., reading selections comprised of complete sentences. One of the primary purposes of the exercises following the first and second “Horizontal Exercises” is to reduce and them eliminate a user's vocalizing words (either out loud or subliminally) while reading.

The second recommended exercise has the user read phrases extending over multiple “vertically stacked” horizontal lines. Each phrase is comprised of two to eight prime words from the master list. One purpose of this exercise is also to demonstrate to a user that the user can read faster scanning down a page if the user does not speak the words while reading the words. The user can adjust the spacing between the stacked horizontal lines.

The third recommended exercise, the “marquee exercise”, has the user read sentences from a selected literary work as the sentences scroll across the screen on a horizontal line. This exercise begins to eliminate the tendency of a user to attempt to speak what he or she is reading. The speed at which words scroll across the screen is adjusted by the user.

The third recommended exercise also has the user read sentences as they scroll from a first horizontal line down to a second horizontal line. The speed at which the words scroll from a first horizontal line to a second line is adjusted by the user.

The fourth recommend exercise, the “highlight exercise”, displays a narrative paragraph and has multiple words highlight in a particular color, say yellow. For example, the first five words of the paragraph are initially highlighted. After a few seconds, words two to six are highlighted. Then after a few more second, words three to seven are highlighted. Accordingly, the highlighting indexes or “travels” through the paragraph. The highlight exercise, like the marquee exercise, begins to eliminate the tendency of a user to attempt to speak when he or she is reading the sentences comprising the paragraph.

The fifth recommended exercise, the “word group exercise” also utilizes narratives, i.e., portions of a book, articles, etc. The computer program contains a list of narratives from which a user can select a desired narrative. The user can also import various narratives. Chapter 1 from the book The Time Machine is an example of a narrative.

The word group exercise has a “Lines” mode and a “Clumps” mode.

### The “Lines” Mode

In the word group exercise, the user selects one to four lines to be shown on the display screen, and selects from one to eight words per line. As would be appreciated by those skilled in the art, the maximum number of words per line which is permitted can be two or more. A maximum of eight words per line is presently preferred in the practice of the invention. The user also selects the reading speed he or she wishes to use. When the exercise begins, the first part of the narrative is displayed on the screen for a selected period of time corresponding to the reading speed selected by the user. After the selected period of time, the first part of the narrative disappears from the screen and is replaced by the second part of the narrative, again for a selected period of time corresponding to the reading speed selected by the user. After the selected period time expires, the second part of the narrative disappears from the screen and is replaced by the third part of the narrative, again for a selected period of time, and so on. In this manner the user reads the entire narrative.

For example, the user selects from the list of narratives Chapter 1 of the book The Time Machine. That chapter begins
“The Time Traveller (for so it will be convenient to speak of him) was expounding a recondite matter to us. His grey eyes shone and twinkled, and his usually pale face was flushed and animated. The fire burned brightly, and . . . ”
   The user can select from one to four lines (although the number of lines available to choose from in the program can be defined as desired, i.e. from one to three lines, or, from two to six lines) and can select from one to eight words per line (although the number of words available to choose from in the program can be defined as desired, i.e. from one to six words per line, or, from two to ten words per line) The user selects three lines with three words per line, and initially selects a slow reading speed of 50 words per minute. The user utilizes his or her computer mouse to put the cursor on and click the “Start” button on the display screen. The first part of Chapter 1 appears on the screen as shown below for a selected period of time corresponding to reading 50 wpm. Notice there are three lines each with three words per line.
The time Traveller
   (for so it
will be convenient
   After the selected period of time, the first part of Chapter 1 disappears from the screen and the second part of Chapter 1 appears as shown below for the selected period of time. Notice that once again there are three lines each with three words per line.
to speak of
him) was expounding
a recondite matter
   After the selected period of time, the second part of Chapter 1 disappears from the screen and the third part of Chapter 1 appears for the selected period of time. And so on.

### The Clumps Mode

The word group exercise also has, as noted, a clumps mode in which multiple groups simultaneously appear on the display screen. The number of groups which can appear on the display screen depends on the size of the display screen, on the size of font selected by the user, on the number of lines in each group, and the number of words on each line. The user selects two or more group and, in the same manner as described above for the “Lines” mode, selects the number of lines and number of words per line. For example, the user selects two groups, and selects two lines and three words for each line. The user also initially selects a slow reading speed of 50 wpm. When the user clicks on the “Start” button on the display screen, the first part of Chapter 1 of The Time Machine appears on the display screen in two groups. The user attempts to read the two groups in the selected period of time.

| | |
|---|---|
| The Time Traveller | will be convenient |
| (for so it | to speak of |

The user reads the group on the left first, and then reads the group on the right. After the selected period of time, the two groups disappear from the screen and two more groups appear on the display screen. The two new groups comprise the second part of Chapter 1. The two new groups appear, as did the first two groups, for the selected period of time. Once again, the user attempts to read the two groups in the selected period of time.

| | |
|---|---|
| him) was expounding | to us. His |
| a recondite matter | grey eyes shown |

The user again reads the group on the left first, and then reads the group on the right. After the selected period of time, the groups disappear from the screen and two new groups appear. The two new groups comprise the third part of Chapter 1. And so on.

The word group exercise, in either the “Lines” mode or the “Clumps” mode, is a critical feature of the system of the invention because it produces a surprising, unexpected result. Namely, it effectively prevents or “breaks” a user from attempting to verbalize what he reads. The marquee exercise and the highlight exercise are effective to a certain extent in this respect, but the word group mode eliminates vocalizing attempts by a user.

The next exercise in the program is reading continuous text. For example, the first page of The Time Machine is shown on the display screen, then the second page, then the third page, and so on. The reading speed is again selected by the user.

In an alternate embodiment of the invention, the supplemental relevant standardized test-related words are not provided with an original reading program constructed in accordance with the invention. The original reading program instead includes the various reading exercises set forth below, and includes the more frequently utilized prime words in a language, such as, for example the 1599 prime words set forth in Table I above. The original reading program is, however, configured to import and utilize the supplemental relevant standardized test-related prime words for any particular vocation, standardized test, or other subject, and to use those words when preparing reading exercises, particularly when preparing the first and second “Horizontal Exercises” set forth above. The supplemental relevant standardized test-related words for a particular vocation, standardized test, etc. are digitized and stored on a computer readable medium (for example a CD, or in the memory or as a file in a computer accessible via the Internet)) such that after the original reading program of the invention is installed on a computer, the original reading program can import the standardized test-related words from the computer readable medium into the original reading program. The original reading program can import and utilize the standardized test related words for any particular vocation, standardized test, or subject. This embodiment of the invention provides more flexibility in using a reading program constructed in accordance with the invention, as well as enabling CD or other computer readable mediums to be marketed separately from the original reading program.

In still another embodiment of the invention, the supplemental relevant standardized test-related words for a particular vocation, standardized test, or other subject are, once again, not provided with an original reading program constructed in accordance with the invention. Instead, the supplemental relevant standardized test-related prime words are offered in a book, CD, or other media which can be purchased separately from the original reading program and studied.

In yet another embodiment of the invention, a program for improving the ability of an individual to work or be successful in a particular vocation includes the steps of offering supplemental relevant standardized test-related words for that vocation in a book, CD, or other media which can be purchased, and of studying the words in said media.

Importantly, it is preferred not to utilize only the speed, in words per minute, to evaluate the reading ability of an individual. Rather, the evaluation tool developed in accordance with the invention is the Effective Reading Rate (ERR). The ERR is the product of words per minute and the results of a comprehension test (which implies a retention and recall metric). For example, 200 words per minutes and a score of 80% on a comprehension test yields an ERR of 200×0.8=an ERR of 160 words per minute.

A more complete example of a reading improvement system constructed in accordance with the invention, and titled “The Reader's Edge (Windows Edition)”, is illustrated below.

### The Reader's Edge (Online Edition)

### Lesson Plan v6

### Lesson Summary

Lessons 1 to 17 are set forth below for use in conjunction with the Reader's Edge program. These lessons are titled:

### Lesson 1: Overview

### Lesson 2: Program Objectives

### Lesson 3: Effective Reading Rate

### Lesson 4: Target Words-per-Minute

### Lesson 5: Recognition Training

### Lesson 6: Motility Training

### Lesson 7: Eye Fixations

### Lesson 8: Horizontal Span

### Lesson 9: Importance of Prime Words

### Lesson 10: Vertical Span

### Lesson 11: Improving Comprehension

### Lesson 12: Word Groups

### Lesson 13: Continuous Text

### Lesson 14: Monitoring Progress

### Lesson 15: Push Down-Push Up

### Lesson 16: High Speed Practice

### Lesson 17: Skills Maintenance

### Supplemental Descriptions Including Screen Illustrations

In addition to the above-noted Lessons, supplemental descriptions of what appears on a computer display screen at various points in the Reader's Edge program are found below after the conclusion of the Lessons, e.g., are found below after Lesson 17.

There are 16 such supplemental descriptions that each are shown below after Lesson 17.

The supplemental descriptions are titled:
1. Opening Screen.
2. Exercise Screen.
3. Warm Up Exercises—Recognition Training.
4. Warm Up Exercises—Motility Training.
5. Visual Exercises—Horizontal Span.
6. Visual Exercises—Vertical Span.
7. Visual Exercises—Marquee Text.
8. Visual Exercises—Highlight Text.
9. Visual Exercises—Word Groups.
10. Visual Exercises—Continuous Text.
11. Visual Exercises—Push Down, Push Up Text.
12. Visual Exercises—High Speed Practice.
13. Oral & Visual Exercises—Say It.
14. Oral & Visual Exercises—Audio Reading.
15. Comprehension Text Questions.
16. RSS Feeds.

Each of the supplemental descriptions 1 through 16 includes one or more illustrations of what appears on the computer display screen during the Reader's Edge program. For example, the description titled 1. Opening Screen, includes a screen illustration titled FIG. 1 in the drawings. FIG. 1 illustrates the opening screen in the Reader's Edge program.

### The Lessons

If under “My Progress” on the opening screen illustrated in FIG. 1, a user clicks on “Lessons: 0 of 22” he can view the Lessons 1 to 22 which are included in the memory of the Reader's Edge computer program. Lessons 1 to 17 set forth below embody, for convenience sake, much of what is included in Lessons 1 to 22.

### Lesson 1: Overview

Welcome to The Reader's Edge!

As you move through the program, we recommend you sequentially read through and follow Lessons 1 to 22. Each of the lessons will assist you to become a more effective and efficient speed reader by providing step-by-step instructions to guide you through the process of learning the necessary methods and techniques to become a better reader.

In today's information-based society, our reading ability is one of the most important skills. With the average reading rate for a typical adult of 160-220 words per minute, the same rate at which we speak, we can frequently feel overwhelmed by the amount we have to read. Many factors contribute to this slow reading speed constant sub-vocalization, limited vocabulary, frequent re-reading and most importantly the lack of proper training. That's where The Reader's Edge comes in! With The Reader's Edge, you will learn how to eliminate your bad reading habits and learn to read effective and efficiently.

To ensure success, we employ a three-step teaching approach to ensure you are encouraged to push yourself to achieve a new level of reading skills.
1. We begin by assessing your current reading abilities.
2. Then we configure The Reader's Edge to an attainable reading goal. This permits the program to monitor your progress and assist you in reaching your goal.
3. Once this has been completed you can begin practicing with the exercises, repeating this process as necessary.

### Let's Get Started!

If you click on “Lessons: 0 to 22” on the opening screen illustrated in FIG. 1, a menu appears listing each lesson. You click on a lesson to go to the lesson. After you complete a lesson, simply mark it as completed by checking the associated check box. Then continue to the next lesson.

Some of the lessons are teaching related and provide text-based instructions and other lessons instruct you to proceed to an exercise. To make this process as easy as possible we have included an Open Section button at the bottom of lessons that are associated with a particular program section. This button allows you to immediately open The Reader's Edge program to the applicable section/exercise.

When ready, go ahead and checkmark this lesson as complete and move onto the next lesson!

### Lesson 2: Program Objective

Let's go over some of the basic concepts about speed reading and The Reader's Edge to ensure you have the proper objectives in mind.

In today's information-based society, reading ability is one of our most important skills. It's easy to feel overwhelmed by the amount we have to read when a typical adult's average reading rate is limited to only 160-220 words-per-minute, about the same rate at which we speak. That's too slow for today's demands.

One of the most important things to remember is that “speed reading” alone is meaningless without simultaneously considering comprehension. The goal of The Reader's Edge is to teach you to unlearn the habits of inefficient readers and learn the habits and skills of efficient readers. Efficient Readers are effective and efficient speed readers. They read better and faster with improved comprehension, retention, and recall. You will be able to apply the new skills you learn with The Reader's Edge to your everyday reading of newspapers, emails, magazines and books, not just while working on the computer. Your newly learned skills will become as permanent as the skill of riding a bike.

An important step to becoming an Efficient Reader is to understand the difference between Efficient and Inefficient reading skills. When learning to read, we were taught Learn To Read skills, i.e., to read one word at a time, aloud to a teacher or parent.

After that point, we moved into a world of silent reading, which requires a new set of skills. These new silent reading skills are the opposite of those required for reading one word at a time out loud. Silent reading skills are the Read To Learn skills that have never been taught in regular reading curriculums. This is where The Reader's Edge comes in. It teaches the silent reading skills necessary for individuals of all ages to become Efficient Readers. Let's look at the important differences between Inefficient Readers and Efficient Readers:

### Inefficient Readers

See and read one word at a time
Fixate on each word in a sentence
Read slowly and laboriously
Re-read words to gain comprehension
Vocalize (subliminally or lip) each word as they are read
Find it difficult to obtain the meaning of unfamiliar words from context, thus reducing comprehension
Generally believe the myth that one must read slowly to have good comprehension
Have limited vocabularies

### Efficient Readers

See and read groups of words with each eye fixation
Do not re-read words
Do not vocalize
Have higher levels of comprehension because they are reading groups of words, or units of meaning, and can derive meanings of words from context
Dispel the popular speed reading myth that one must read slowly to have good comprehension
Have large vocabularies

Once you understand the differences between the two types of readers, the benefits of becoming an Efficient Reader are obvious.

When ready, move onto the next lesson and start working with the program.

### Lesson 3: Effective Reading Rate

This lesson will take about ten minutes to complete and will measure and record your Effective Reading Rate. Your Effective Reading Rate works as an indicator of your actual reading abilities.

Similar to other self-improvement activities, you need to establish a starting point to successfully measure your improvements.

We do this by first measuring your reading speed in Words per Minute (WPM). Then we measure your ability to comprehend the text you just read by taking a comprehension test. When finished, your Effective Reading Rate will be determined by multiplying your reading speed (WPM score) by the percentage of comprehension questions you answered correctly.

To proceed, click on the “Tests and Progress Reports” section or button. This section is shown on the left hand side of the opening screen illustrated in FIG. 1.

We recommend you take 2-3 different comprehension tests so the Effective Reading Rate you achieve will be an accurate representation of your current reading skills.

When finished with this lesson, mark it as complete and move on to the next lesson.

### Lesson 4: Target Word-Per-Minute

Now that you have obtained an Effective Reading Rate that is an accurate representation of your current level of reading skills, let's configure the program to an achievable reading goal.

### Setting Your Target Word-Per-Minute.

When you select Lesson 4, menu buttons extending horizontally across the top of the screen from left to right. One of the menu buttons is “My Settings”. Click on “My Settings”, read the tips and set your Target WPM. When finished, press the “Apply Changes” button to save your settings.

Congratulations, you have set the program to your reading goal! Go ahead, mark this lesson complete, and move onto the next lesson to get a brief overview of the exercises.

### Lesson 5: Recognition Training

Recognition Training is the first exercise in The Reader's Edge. It is intended to be used as a warm-up tool. Just as athletes warm-up their muscles before entering a competition, so must a reader warm-up his/her brain and eyes before rigorously beginning a reading exercise.

Since the Recognition Training and Motility Training exercises are as warm-up exercises, you only need to spend a few minutes each day practicing with one or the other. You don't need to work on both each day.

### Purpose

The purpose of this exercise is to train you to accurately see, read, process and recall visual objects faster. Your goal is to accurately recognize words and numbers at the highest rate, with 80% accuracy. Be sure to read all of the instructions before proceeding to the exercise.

As discussed in the Program Objective lesson, one of the biggest problems slow readers must overcome is vocalization. This habit was formed when learning to read by orally pronouncing words to assist in the learning process. As you practice with this exercise you'll learn to recognize numbers and words faster and more accurately without saying them in your head.

### Here's How

1. On the Opening Screen illustrated in FIG. 1, click on “Exercises” in the left hand panel. A drop down menu will appear under “Exercises”. This drop down menu can be seen in FIG. 2. Click on “Recognition Training” in the drop down menu. The screen display shown in FIG. 3 appears.
2. Set the “Digits” to 4 and the “Rate” to Slow. Gradually increase the display number and rate of speed until you can successfully see the entire number in one glance.
3. Your objective is to see and recall all of the digits in a single glance. Focus on the “LOOK HERE” box and click the New Display button.
4. Enter the number or word you saw in the “LOOK HERE” box.
5. Click on the button with the check mark, or press the Enter key on your computer keyboard, to verify you entered the correct answer.
6. When you are able to get to 5 or more in a row correct, increase the “Digits” (lower left at bottom of screen) to 5.
7. Each time you are able to get 5 numbers or words correct in a row, increases the “Digits” selected.
8. When you get 5 or more in a row at a “Digits” selection of 7, increase the “Rate” and reduce the “Digits” back down to 4. Continue the process until you can get five numbers or words in a row correct at a “Digits” setting of 7 and a “Rate” setting of 7.

### Training Techniques

Use the following techniques to recall numbers accurately:
1. When you see 7356, don't think 7 3 5 6, think of them as 73 and 56.
2. When you get to 5 digits, i.e., 54832, remember the highlighted center number 8, then try and recall 54 and 32.
3. When you see the seven digit number, e.g., 3858613, remember the highlighted center number 8 and then recall the others as 385 and 613.

### Completing the Exercise

Keeping in mind this exercise is simply a “Warm-up” exercise, you'll only practice with it for a few minutes a day prior to working with the Visual exercises.

Did you know? This exercise is the result of extensive research conducted by the Athletic Perception Institute. Professional athletes in baseball, football, basketball and soccer use it to increase their visual acuity. The Athletic Perception Institute's research confirms that people who mastered the skills taught in this exercise improve the speed of recognizing objects 25% to 150% faster. This improvement results in enhanced eye-hand coordination, increased comprehension and improved short-term memory; all of which are vital to improving one's reading skills.

When ready, mark this lesson as complete and move onto the next lesson.

### Lesson 6: Motility Training

The objective of this exercise is, as was the case in Recognition Training, to help improve your ability to quickly process information. It's designed to train your eyes to move faster and more accurately from place to place, while remembering how many times you've seen the pre-chosen image. The more “looks” you can make while reading, the faster you will read.

### Purpose

The purpose of this exercise is to train you to see and recall how many times a pre-chosen image is flashed on the screen during each exercise session.

Your goal is to train your eyes to move faster and more accurately from place to place by gradually increasing the rate images are displayed.

### Here's How

1. In the “Exercise” drop-down menu shown in FIG. 2, click on “Motility Training” to make the screen display in FIG. 4 appear.
2. Start the exercise displaying objects left to right, then right to left, top to bottom, bottom to top, and finally look at scattered targets.
3. As the exercise is running, be sure to MOVE YOUR EYES and not your head! The eyes can move faster than a head movement. Don't try to look in the middle to see the other objects. Your eyes need the movement.
4. Take note of the target object, then click the “Start” button or press the Enter key.
5. While the exercise is running, count the number of times you see the target object.
6. When the exercise stops, click on the number of times you saw the target object.
7. Continue practicing with this exercise, increasing the speed each time you get five correct answers in a row.

### Completing the Exercise

We recommend that you spend a few minutes working with this exercise before moving on to the Visual exercises to ensure you maintain your new skills and get yourself ready to read.

Did you know? Research conducted by the Athletic Perception Institute indicates that improving your ocular control (eye muscles) allows you to read faster. All readers make very short involuntary right-to-left movements while reading. These are called regressions. These habits were developed while learning to read. Readers search with their eyes continually, thereby developing this habit. For example, names, places and dates may require a return look. Regressions are a very small movement that slow down your reading rate and hinder good comprehension. Working with this exercise will dramatically reduce the tendency to regress while reading.

When ready, mark this lesson as complete and move onto the next lesson.

### Lesson 7: Eye Fixations

Did you know? The only time one can “see” anything, is when the eye is not moving. When the eye stops moving to see, or read something, it's called an eye fixation.

In this lesson, we discuss “fixations” and how they affect your reading speed. Most people's eyes fixate (stop and pause) 4 to 6 times or more per line while reading. An Efficient Reader can read the same amount of text in only three fixations. Fixations are one of the main factors that determine your reading rate. It's a basic fact: the more stops you make while reading, the slower you read and the more your comprehension is reduced.

Training your eyes to reduce the number of fixations per line allows you to read multiple words at time, helping you to read faster. Why? Because when you read more than one word at a time, you're reading units of meaning and you become the recipient of the range of benefits that accrue to Efficient Readers. The reason for this is it's easier to understand the meaning of text by reading groups of words rather than reading one word at a time. One of the best ways to do this is by practicing seeing and reading words at high rates of speed, which we'll practice in the next exercise.

Now that you have a good understanding of how the eye works and how it affects your reading speed, let's move on to the Horizontal Span exercise and start working with words and phrases.

Mark this lesson as complete and move onto the next lesson.

### Lesson 8: Horizontal Span

By now, you should have a solid understanding of The Reader's Edge goals and teaching philosophy. It's to teach you to see and read groups of words, in a single glance, without vocalizing, i.e., to read silently! Let's start working with the Horizontal Span exercise. The Horizontal Span is a great exercise to learn how to overcome some of the common habits of slow readers. In this exercise, you'll work with words from The Reader's Edge Prime Words collection (discussed in the next lesson).

### Purpose

The purpose of this exercise is to teach you: (1) the limitations of slow readers who vocalize words as they read and (2) to gain confidence that you have the capability to see, read and process groups of words, without vocalizing, 3 to 5 times faster than if you vocalize words as they are read.

This exercise has multiple practice modes, but we're going to focus on the Words and Phrases sections. The Words section demonstrates that when you vocalize, your maximum reading rate is restricted to the rate at which you speak. The Phrases section is helpful because it trains you to see and read word groups rather than seeing and reading word by word. Reading groups of words helps expand your peripheral vision and gets you in the habit of reading more than one word at a time.

### Words Section

1. In the “Exercise” drop-down menu shown in FIG. 2, click on “Horizontal Span” under the “Visual” heading.
2. A screen display comparable to that in FIG. 5 appears.
3. At the bottom of the display set “Mode” to “Words” and under “Confirmation” select “Multiple Choice”.
4. Set “Display” to “3” words at “120” WPM.
5. Start the exercise by clicking on the “Start Automatic Mode” button.
6. As words are displayed, say them aloud while they are visible on the screen.
7. With “Confirmation” set to “Multiple Choice”, the program presents you with four possible answers corresponding to the words displayed. You have two chances to choose the right answer. Remember, our goal is to TEACH, not TEST. Therefore, if you have trouble recognizing a word or phrase, click on the “Display” button to see it again.
8. Gradually increase the WPM rate until you can no longer say the words aloud, while they are visible on the screen. When this occurs, usually around 160 to 225 WPM, move to the Phrases section of the exercise.

### Phrases Section

1. Click the “Properties” button in the lower right hand corner, and change the “Mode” to “Phrases”. Make sure that “Confirmation” is set at “Multiple Choice”.
2. Set “Display” to 3 words and increase the “wpm” rate to 25 WPM above the final rate used when the “Mode” was set to “Words”. FIG. 6 depicts a screen display when the “Mode” is changed to “Phrases”.
3. Start the exercise by clicking on the “Start Automatic Mode” button. As a phrase is displayed, do not say it aloud while it is visible on the screen. We now want you to say the phrase to yourself AFTER it has left the screen.
4. When a “Multiple Choice” confirmation is displayed, click the button that is next to the answer that corresponds to the phrase that was displayed.
5. Gradually increase the “wpm” rate until your rate is 3 to 5 times the maximum rate you achieved in the “Words” mode.
6. Increase the “Display” number by one, and drop the “wpm” rate back down to the “wpm” you achieved in the “Words” mode. Then gradually increase your “wpm” rate once again.
7. Repeat this process until you get to a “Display” value of 8 words and work up to a “wpm” rate that is 3 to 5 times the maximum rate you achieved in the “Words” mode.

### Training Techniques

You can change the “Confirmation” selection to “Enter Answer” or “No Confirmation”. “Enter Answer” is a true test of your memory skills, as it forces you to recall the displayed information.

With “No Confirmation”, the program automatically cycles through the phrases, which allows you to automate the process and practice at your own pace.

To further enhance your training you can set the font alignment to Justified text. Working with Justified text forces the text to use the entire horizontal display area and displays the outer most objects in red which assists your eyes in expanding your horizontal vision.

### Completing the Exercise

When you have successfully completed the Words and Phrases sections of this exercise at your Target WPM rate, you are ready to move onto the next exercise.

When ready, mark this lesson as completed and move onto the next lesson.

### Lesson 9: Importance of Prime Words

When you work with the Horizontal Span exercise, you work with Prime Words. Prime Words are the most frequently used words in the English language.

Prime Words have three important characteristics:
1. They are immediately recognizable
2. They do not need to be decoded (Decoding is the ability to apply the reader's knowledge of letter-sound relationships, including knowledge of letter patterns, to correctly pronounce written words. In the case of a reader who has mastered the Prime Words, this process happens automatically.)
3. The eye does not have to fixate on them

We created the Prime Words by compiling more than 500 million words and then sorting them by frequency of use. We found that 2,100 words make up approximately 75% of all words used in the English language today. Within those 2,100 words, the first 300 represent 50% of all English words in print and the top 15 encompass 25% of all English words in print.

The Reader's Edge helps you to make these words an integral part of your vocabulary. Mastering these words will be a major help for you to make you an Efficient Reader. You will soon be able to seamlessly read groups of words, in a single glance, without vocalizing. Reading will become less of a chore and more of a pleasure.

Now that we've covered the importance of working with Prime Words, proceed to the next lesson to continue your training.

### Lesson 10: Vertical Span

The Vertical Span exercise is a two-part exercise that displays 2- to 8-word phrases, in and out of sequence. In the first part, “In Sequence” phrases are displayed representing a single coherent thought. In the second part, “Out of Sequence” phrases are displayed with the words jumbled, to purposely make it difficult to vocalize as you read.

### Purpose

The purpose of this exercise is to teach you to expand your horizontal and vertical eye span, while decreasing the tendency to vocalize.

### In Sequence

1. In the “Exercise” drop-down menu shown in FIG. 2, click on “Vertical Span”. Ensure the “Word Order” is set to “In Sequence” with “Confirmation” set to “Multiple Choice”.
2. Set the “Display” to 3 word phrases at a speed of 120 “wpm”.
3. You can adjust the display area by clicking on the ruler to the left of the text and/or across the top so that the words are not spread out. FIG. 8 illustrates a display screen in the Vertical Span mode with a “Word Order” of “In Sequence” selected. The display area has been increased sufficiently to temporarily cover the “Word Order”, “Confirmation” and other settings.
4. Click the “Start Automatic Mode” button to display a phrase.
5. After a phrase is displayed, four possible answers are displayed in “Confirmation” box. Select the phrase corresponding to the phrase that flashed on the screen to confirm you were able to read the phrase.
6. Gradually make the exercise more challenging by increasing the number of words in each phrase (i.e., the “Display” selection) and/or the “wpm” rate.
7. As you progress through the exercise, remember the purpose is to TEACH, not to TEST, therefore, at any time you can click on the “Repeat Display” button to show the last displayed phrase.
8. When you are able to display and identify phrases containing four or more words at your target words-per-minute rate with at least 80% accuracy, proceed to the Out of Sequence section of this exercise.

### Out of Sequence

The purpose of the “Out of Sequence” format is to assist in decreasing any tendency you have to vocalize words. Why? A group of random jumbled words is difficult to understand and even more difficult to vocalize. Your task is to see, read and process the words as a group, then re-arrange them in your mind, so that the group of random words becomes an understandable and logical phrase.
1. Ensure the “Word Order” is set to “Out of Sequence” with “Confirmation” set to “Multiple Choice”.
2. Set the “Display” to 3 word phrases at a speed of 120 “wpm”.
3. Click the “Start Automatic Mode” button to display a phrase.
4. Continue working with this exercise making it more challenging by increasing the number of words in a phrase (i.e., increasing the “Display” number and/or the “wpm” rate). FIG. 7 illustrates a display screen in the Vertical Span mode with a “Word Order” of “Out of Sequence” selected. The display area has been increased sufficiently to temporarily cover the “Word Order”, “Confirmation” and other settings.

### Training Techniques

There are two ways to use of this exercise:
1. Expand your horizontal and vertical vision: To do this, change the text alignment to Justify text. When practicing with the alignment set to Justify text the phrases are displayed using the whole display area, you can adjust the size of the display are using the horizontal and vertical rulers. As you practice with Justified text your eyes are learning to see a wider area, making it easier to read larger groups of words.
2. Improve your spelling and memory: To do this, simply change the confirmation setting to “Enter Answer”. With this setting you have to remember the displayed phrase, and then type the answer into an input box.

### Completing the Exercise

Your goal is to be able to display and identify phrases containing four or more words at your Target wpm rate, with at least 80% accuracy.

When ready, mark this lesson as complete and move onto the next lesson.

### Lesson 11: Improving Comprehension

One of the biggest myths surrounding speed reading is the perception that your comprehension will suffer if you try to read faster. The opposite is true!

To improve your comprehension it's helpful to understand the three elements that are the building blocks of good comprehension. With this knowledge, you'll better understand how and why the new reading skills you're learning with The Reader's Edge will improve your comprehension, retention and recall.

The three elements are:
1. Fluency—reading at the right speed
2. Vocabulary—having knowledge of the vocabulary in the material you read
3. Knowledge Base—building on prior experiences

### Fluency

This means reading at the right speed. If you read too slowly, it's like watching a movie in slow motion. It's hard to concentrate when things are happening slower than the speed of your thoughts. Learning to read at the right speed is essential to help your comprehension, as you will be reading in units of meaning rather than one word at a time. Not only will your comprehension improve, but if you run across a word you do not know, reading in groups of words will help you deduce the meaning from the context; something you cannot do by reading inefficiently one word at a time.

### Vocabulary

Vocabulary is important for comprehension because if you do not know the “dictionary meaning” of a specific word, it may be difficult to get an understanding of what message or information the writer wants to convey. When you come across a word you do not know, it's best to first try to deduce its meaning from the context in which it is used. You can then continue reading with improved comprehension.

### Knowledge Base

Knowledge base is all about what your life experience, interests and vocabulary level contribute to, or by their omission, act as obstacles to comprehension. Research indicates that 90% of your vocabulary comes from what you have read since the 4th grade. So the more you read, the more your knowledge base will grow—making you a better reader!

A good example of the significance of Knowledge Base is if you know nothing about baseball and you read the terms “sacrifice fly”, “third base” or “fly ball.” These words would have no meaning. Even if you were given a page or two to explain what they mean, it would still leave you with no real knowledge and understanding of the terms.

Another example would be if you read the phrase, “the Great Lakes.” Depending on your knowledge base, these three words will either immediately conjure up the image of the five great lakes and their names, or these words will mean nothing and you will not have gained any comprehension of what the author wanted to convey from those three words.

You can now understand that the more you read the more your knowledge base will expand. The key to becoming an Efficient Reader is to expand your vocabulary, make reading a lifelong commitment to expand your knowledge base, and learn to read fluently at the right speed.

When ready, mark this lesson as complete and move onto the next lesson.

### Lesson 12: Word Groups

In this lesson, we'll work with the Words Groups exercise. Here, we transition from working with individual groups of words to working with complete narratives. This exercise teaches you to increase your reading speed by leaps and bounds by reading, at a single glance, word groups at the speed with which you read single words.

### Purpose

The purpose of this exercise is to teach you to see and read in groups of words without vocalizing, helping you to become an Efficient Reader.

### Here's How

1. In the “Exercise” drop-down menu shown in FIG. 2, click on “Word Groups” under the “Visual” heading. The screen display that appears permits selection of the number of “Lines” in a group (one to four), of the number of “Words” per line (2 to eight), of the “wpm” (50 to 2500), of the “Font” size, of whether you want the reading speed to automatically gradually increase, and of the justification of the piece being read (right hand justification, centered, or left and right hand justification). Most individuals end up selecting groups with two to three lines and two to three words per line.
2. You can adjust the display area by clicking on the ruler to the left of the text and/or across the top so that the words are not spread out. FIG. 12 illustrates a display screen in the Word Group mode. The display area has been increased sufficiently to temporarily cover some of the settings noted above.
3. In the settings made for FIG. 12, only a single group at a time appears, and each group comprises three lines with three words in each line. In the settings made for FIG. 13, seven groups at a time appear on the screen and each group include three lines with three words in each line. The number of groups which appear on the screen at the same time can be adjusted as desired.
4. After you make a reading selection (the program has a library of reading selections each typically 200 to 500 words long), set the number of “Words” in each line in a group, set the number of horizontal “Lines” in each group, and set the “wpm” reading rate, press the “Start” button and begin reading.
5. As you become comfortable with the exercise, increase the number of “Words” in each group, and then increase the number of “Lines”.

### Training Techniques

You can use this exercise in “Manual” or “Automatic Mode”. Working with “Manual Mode” helps you get familiar with seeing and reading groups of words displayed in multi-line fashion at a rate you control. To use this mode, click the “Display Next Group” button to display new groups of words as quickly as you can read them. “Automatic Mode” challenges you to increase your horizontal and vertical vision, by testing your ability to see and read larger groups of words with each eye fixation at a rate controlled by the WPM setting.

### Completing the Exercise

Continue to practice with this exercise until you are able to read at or near your Target WPM Rate and are satisfied with your progress.

When ready, mark this lesson as complete and move onto the next lesson.

### Lesson 13: Continuous Text

This lesson builds on the skills taught in the previous exercises while introducing the use of an eye-pacer in the Continuous Text exercise to assist you in learning how to pace yourself properly when reading.

This exercise included four different pacer modes: No Pacer mode allows you to move the selection at your own pace, without the help of a pacer. Analog mode displays a pacer moving in a fluid consistent movement. In Digital mode the pacer moves line-by-line, much like the stepped motion of the second hand in a digital clock. Manual mode allows you to control the speed of the selected pacer.

### Purpose

The purpose of this exercise is to teach you to read text in formats you see daily on your computer screen, in newspapers, magazines and books. Your goal is to read text at or above your Target WPM rate while working with the exercise in single and two-column display modes.

### Here's How

1. In the “Exercise” drop-down menu shown in FIG. 2, click on “Continuous Text” under the “Visual” heading. The screen display that appears permits “Selection” of a reading selection, setting the “WPM” at which you want to read, and selecting the “Pacer” that you want to use. Initially it can be an illustrated pencil which move along the screen, or an underline which continuously underlines a set number of words but moves along the lines being read.
2. Make a reading “Selection”.
3. Start by using the more easily noticeable pacers, we recommend either the Line or Pencil. In FIG. 14 the pace is a pencil. The end of the pencil can be seen in the right hand margin of the left hand page about half way down the page. As you become more comfortable working with this exercise, you'll want to change your pacer to a less obtrusive one.
4. The pacer Position setting can be adjusted to Left, Center or Right to fit your personal preference.
5. In the beginning, we suggest you choose the largest font and adjust the text margins to the narrowest position until there are 2-3 words on a line.
6. Set the “Mode” to “Analog”, then press the “Start” button to begin the exercise. Your goal is to read the text at the same pace as the reading pacer.
7. Practice reading the lines by trying to force yourself to read in groups of words to reduce the number of stops (fixations) your eye makes per line.
8. Continue practicing with the exercise, adjusting the WPM setting to match your current abilities.
9. Gradually increase the text margins and decrease the font size until you see up to a maximum of 12 words per line.
10. When you're comfortable reading groups of words in a single line of text, move to 2 Column View. The purpose is to simulate reading text displays in columns.

### Training Techniques

To expand your practice with this exercise you can change the “Mode” setting. When set to “Digital”, the pacer jumps line by line in a digital fashion. The “No Pacer” mode does not display a pacer at all and you control the speed by pressing the “Page Down” or “Space Bar” or clicking the “Turn Page” button when you're ready. “Manual” mode is very similar to the “No Pacer” mode except that you still use a pacer while reading and pressing the “Down” key or “Space Bar” to move the pacer down to the next line.

### Completing the Exercise

As you practice with this exercise, your goal is to select a less and less obtrusive Eye-Pacer to help you overcome the need to rely on the pacer to pace your reading. When you are able to read at or above your Target WPM rate in both single and two column display, you are ready to move to the next lesson.

### Lesson 14: Monitoring Progress

There is a famous management mantra that if you cannot measure it you cannot manage it. A successful self-improvement program requires that you be able to measure your progress. With The Reader's Edge you have the ability to generate and print reports of your day-to-day improvements.

The goal of this lesson is to ensure you are able to measure your newly learned and improving reading skills.

In the Effective Reading Rate lesson, we outlined the importance of properly setting your Target WPM to ensure you're working towards a goal that is both realistic and attainable. When working with the exercises in this program, the goal is to achieve a reading rate at or beyond the Target WPM you set. Hopefully, you have been able to reach that goal.

As you continue to work with the program, we recommend you frequently re-take comprehension tests to ensure your Target WPM is set correctly based on your current abilities. When done, you can open the Progress section and generate and print progress reports.

It's very important to understand that learning new reading skills is not an overnight event. Practice and motivation are important. Even a little improvement in your reading skills will have a dramatic impact.

Imagine the benefit of even a small increase of 100 words per minute in your reading speed. If when you begin the program you are able to read at 175 WPM, increasing your reading speed 100 words per minute to 275 WPM means you could read the same amount of material in 40% less time. This is equivalent to reading an average of 31 more 250-page books a year!

When ready, mark this lesson as complete and move onto the next lesson.

### Lesson 15: Push Down-Push Up

One of the best ways to read faster is to time your practice. This two-part exercise teaches you how to read more text in less time. By becoming “familiar” with the text you read, you will be able to read a larger amount of text in a shorter time.

### Purpose

The purpose of the Push Up-Push Down exercise is to demonstrate the dramatic benefits that you will experience when you're familiar with the material being read. An additional benefit of being familiar with the material being read is that it aids in reducing the tendency to vocalize as you read.

The separate, but complimentary, Push Down and Push Up exercises demonstrate and reinforce understanding why familiarity with the subject matter and vocabulary are major factors contributing to efficient reading.

Begin working with the Push Down practice.

### Push Down

During Push Down you'll read a given length of text in 60 seconds and then the same text in sequentially shorter periods.
1. In the “Exercise” drop-down menu shown in FIG. 2, click on “Push Down-Push Up” under the “Visual” heading. The screen display that appears permits selection of “Push Down” or “Push Up”. Select “Push Down”. The display also permits a reading selection to be chosen from a list of selections. Pick a reading selection.
2. Click “Start” to begin reading. Use the “Turn Page” button or scroll bar to display additional text. Your goal is to read as far as you can before the timer goes off.
3. After 60 seconds, a timer will ring. Stop reading and click on the last line you read. If you reach the last page before the timer sounds, DO NOT wait for the timer, click on the last line of text.
4. To assist in recalling what you just read, the exercise displays a note-taking window. Follow the instructions and take notes on what you just read.
5. Click the “Start” button to initiate the 50-second interval. In the 50-second period, the goal is to read as far as you read in the 60-second period and then read as far as you can beyond that.
6. When the 50-second timer rings, click on the last line you read and add some additional notes.
7. Repeat this process with the 40- and 30-second intervals. At the end of the 30-second interval, the exercise displays a summary containing the reading rate you achieved for each segment.
8. When you are able to meet and exceed the highlighted line during each practice interval you're ready to move to the Push Up section.

### Push Up

Push Up practice is designed to have you read a given length of text in 60 seconds and then an additional percentage of new text over what you read in 60 seconds. The new text is to be read in sequentially shorter periods, ranging from 5% to 50% more text than the previous interval.
1. Choose a reading selection that interests you.
2. Select “Push Up” and set the “Increase Words By” setting to 5%.
3. Proceed as you did with the “Push Down” practice, namely, press the “Start” button and read as far as you can before the practice timer goes off.
4. When the timer goes off, click on the last line you read. If you reach the last page before the timer sounds, DO NOT wait for the timer, click on the last line of text.
5. After clicking on the last line you just read, the program will automatically highlight the line of text that is 5% further (assuming you selected a 5% increase). The purpose is to induce you to push your reading skills to read more text in less time.
6. As you become comfortable with your progress and you're able to read to the highlighted line, set the “Increase Words By” setting to a higher value to make your practice sessions more challenging.

### Completing the Exercise

Continue practicing with the “Push Up” section of this exercise until you are able comfortably to read to the highlighted line at reading rates equal to or greater than your Target WPM rate.

When you're ready mark this lesson as complete and move to the next lesson.

### Lesson 16: High Speed Practice

This lesson further reinforces the message of the preceding Push Down-Push Up lesson regarding the importance of familiarity with the material you read. The High Speed Practice exercises teaches you effective and efficient strategies and techniques to assist in becoming familiar with material you intend to read, so that you will whatever you select in the most efficient manner.

### Purpose

The purpose of the High Speed Practice exercise is to teach and demonstrate the following effective and efficient strategies and techniques that will accelerate your ability to become a more efficient reader by teaching you how to quickly become familiar with the material you intend to read:

### Do not Read Everything at the Same Speed

Reading rates are much like driving a car. You match your driving to road conditions. You may drive on the highway at 90 MPH. In slippery weather you'll drive more carefully. In the city you'll drive slower, etc. So, with reading, you must adjust your reading speed, techniques and strategies to the type of material being read, to the reason for reading the material, and to the information you want to retrieve from what you are reading. Above all, you do not want to commit one of the main errors of inefficient readers, namely, attempting to read everything at the same speed.

### Pre-Read, Read and Post-Read

Pre-Reading assists in quickly becoming familiar with what is to be read. Pre-Reading allows you to gain some familiarity with the content. As a result, you read faster with improved comprehension, retention and recall. Pre- and Post-Reading involves skimming and scanning skills.

In the case of a book (or a large document), we suggest you read the front and back covers, the introduction, the preface, subtitles, sub-headings and the Table of Contents. Then flip through the book. While skimming, read the bolded chapter headings, and the first sentences (the topic sentences) in each paragraph. It's OK and normal while skimming to occasionally slow down to read a full paragraph of particular interest. By employing this strategy to become familiar with what you intend to read, you will read much more efficiently as compared to just plunging in and trying to read from page one to the end.

Post reading locks in the information you wish to retain from the material you've read.

The High Speed exercise uniquely facilitates learning Pre-Reading and Post-Reading skills. It does so by formatting the first line of every paragraph in bold type. By having the first line of each paragraph presented in bold, you will experience the ease at which you can read these first lines at a comfortable rate of several thousand words per minute.

### Skimming

The basic purpose of skimming is to become familiar with the material you intend to read, and secondarily to determine whether you will even decide to read it. Skimming is done at a minimum speed of 3 to 4 times faster than normal reading. This exercise will teach more targeted methods that will permit you to skim at a rate of several thousand words per minute.

When skimming or scanning, look for the author's use of organizers such as numbers, letters, steps, or the words, first, second, or next. Look for words that are bold-faced, italicized, or in a different font size, style, or color. Sometimes the author will put key ideas in the margin.

### Scanning

The basic purpose of Scanning is to quickly obtain specific information, e.g., a date or a name, when looking up a word in the telephone book or dictionary. Scanning involves moving your eyes quickly down the page seeking specific words and phrases. Often, once you have scanned a document, you might go back and skim it before actually reading it.

Remember: The first goal in all aspects of reading is to know what information you want to get from the material you read. In this exercise, we suggest that your goal is to try to read the first sentence of each paragraph or the first words in the first sentence of each paragraph.

### Here's How

1. In the “Exercise” drop-down menu shown in FIG. 2, click on “High Speed Practice” under the “Visual” heading.
2. Choose a reading selection that interests you.
3. For Automatic Operation click the “Start” button. For Manual Operation, click the “Display Next Page” button. We suggest you start with Automatic operation at the default WPM setting of 50,000.
4. Check the “Loop” box to continuously display text.
5. Press the “Start” button. At this rate, it is not possible to read anything, certainly not the first sentences in each paragraph.
   Press the “Pause” button and change the WPM setting to 25,000. Start the exercise by pressing again the “Pause” button. At this rate, you will begin to see the words, but not really be able to recognize groups of words.
6. Gradually reduce the WPM rate until you can begin to see and recognize blocks of words.
7. When you reach the three to five thousand WPM range you will recognize that you can easily see, read and process the first sentence in each paragraph.
8. Continue practicing with this exercise and working on your skimming skills. Be sure to practice the skimming strategies discussed above. This will ensure you're able to quickly look for and grasp the key points of the text you're reading.

### Completing the Exercise

When you're satisfied with your progress, take a Speed and Comprehension Test to confirm your new reading skills, and then move to the final lesson, Skills Maintenance.

### Lesson 17: Skills Maintenance

Now that you've had a chance to work with The Reader's Edge and each of its unique exercises, let's go over how you can maintain your new skills.

When you first started, we recommended you test your reading rate and set the Target Word-Per-Minute rate to reflect a realistic reading goal. Hopefully you're on your way to achieving that goal. It's important to remember that learning to improve your reading skills is not an overnight event. Practice and patience are keys to your success. It may still be difficult to resist the urge to vocalize, but with time and practice, you'll minimize and eliminate that tendency.

Below is a list with the top-ten reading tips. This list will assist you in improving your reading skills. Try to apply these reading tips to your everyday reading.

### Ten Reading Tips

1. Try holding a toothpick in your mouth or chew some gum while practicing with the exercises. This will assist in reducing your tendency to vocalize words (subliminally or lip) as you read.
2. Practicing reading newspapers and magazines. Because they are printed in columns it is easier to see and read in groups of words.
3. Sign up for a Word-A-Day service. Expanding your vocabulary is a key element that helps you read better and faster with improved comprehension, retention and recall.
4. When reading, don't focus on each word; instead try to see, read and process groups of words with each eye fixation.
5. To read better and faster always ask yourself why you are reading the selection. Then adjust your reading rate to your purpose, i.e., are you looking for specific information, a name, a date or for overall general understanding?
6. You learn to play the piano by practicing, not reading about it. Equally true, you will only learn to read better and faster by practicing. To ensure your newly learned reading skills stay honed, we recommend practicing with the program for a minimum of 15 minutes every other day.
7. Comprehension, retention and recall are improved by (1) reading at the right speed, (2) having a good vocabulary, and (3) knowledge base, (i.e., do you know and understand common phrases like kick start, fly ball, left field, etc).
8. Trouble with comprehension? You must go back to basics. There is no way to get around the three pillars of comprehension noted in Tip #7. However, once you understand this, focus on the first three exercises to master the Prime Words vocabulary and learning to see as well as, read and process 3 & 4 word phrases. Don't worry about your WPM speed. You are in control and you're not to be compared to anyone else. Go at your own speed and slowly build up confidence in moving ahead step-by-step.
9. 90% of your vocabulary comes from what you have read after 4th grade. The more you read, the better your comprehension; this is because reading improves your vocabulary and knowledge base.
10. If you follow the practice of quickly pre-reading to become familiar with the content, then read it carefully, and finally post-read it, you will improve your comprehension, retention and recall for all your reading experiences.

Following these reading tips will help you as you improve your reading skills.

Now that you have finished the lessons outlined here, retest your reading skills and adjust your Target Word-Per-Minute setting to reflect your new reading skills. The next step is to continue working with the exercises and practicing these techniques with your everyday reading.

Remember, The Reader's Edge is the tool to help you enhance your skills. You should regularly return to the program to refresh or further enhance your reading abilities.

We welcome program feedback from our users and ask that you provide us with suggestions pertaining to your experience with The Reader's Edge. This helps us continually improve the most effective reading program available.

### 1. Opening Screen

1. Opening Screen
   a. The opening screen is illustrated in FIG. 1 on the next page. This is what a User sees when he or she opens the Program.
2. Table of Contents (TOC) is on the Left Hand Panel
   a. My Progress
   b. Welcome—Getting Started
   c. Exercise
   d. Test & Progress Reports
   e. Online Content
   f. RSS Feeds
3. The Right Hand screen is a Welcome message to the User
   a. Lesson Plan
   b. How to
   c. Program Feedback
   d. Tell a Friend

### a. 2. Exercise Screen

1. Table of Contents (TOC) is on the Left Hand Panel
a. My Progress
b. Welcome—Getting Started
c. Exercises
d. Test & Progress Reports
e. Online Content
f. RSS Feeds
2. Click on “Exercises” in the opening screen of FIG. 1, produces the drop down menu seen under “Exercises” in FIG. 2.
3. In the Right hand portion of the screen in FIG. 2 is an Overview of the Exercises
   a. Described the Warm Up Exercises
   b. Defines Exercise into two categories
      1) Visual
      2) Oral& Visual

### 3. Warm Up Exercises Recognition Training

All body movements are in reaction to what you see.
1. This Exercise is unique to a reading comprehension program and is used under license from the developer. The exercise is used by virtually all professional sports teams to improve the visual acuity of their team members.
2. Recognition Training
   a. Improves visual acuity (how quickly you see things and remember them) by testing your ability to recall words and/or numbers as they are displayed at a User-controlled rate of speed.
   b. Your goal is to accurately recognize the words or numbers at a rate you continue to increase, while increasing the number of digits from 4 to 7, or the number of letters in the words, from 4 to 7.
   c. FIG. 3 illustrates a screen which appears during Recognition Training.

### 4. Warm Up Exercises—Motility Training

All body movements are in reaction to what you see
1. This Exercise is unique in a program for improving reading. I is used by virtually all professional sports teams to improve the visual acuity of their team members with respect to their sports.
2. Motility Training.
   a. Displays
      (1) Images by direction.
      (2) Variety of images.
   b. Improves User's ability to quickly process information.
   c. Designed to train User's eyes to move faster and more accurately from place to place.
   d. The more a User improves this skill the easier it is to see, read and process more than one word at a time with each eye fixation.
3. FIG. 4 illustrates a screen which appears during Motility Training.

### 5. Visual Exercises—Horizontal Span

b. 1. Displays Random Words & Two-Word to Eight-Word Phrases at User controlled rates.
1. a. The Random Words & Phrases are composed of the Literacy

Company's Prime Words which are (1) immediately recognizable, (2) do not need decoding and (30 the eye does not fixate on them.
2. b. First and last word in RED to facilitate training.
3. c. FIGS. 5 and 6 on the following pages illustrate screens which appear during the horizontal span exercises.
c. 2. Horizontal Span Goal
4. a. Pursuant to the best pedagogical methodology, it is important for a student to gain confidence that they have they ability to learn whatever is being taught
5. b. TLC wants to teach how to:
   1) Unlearn the habits of inefficient (slow) readers, i.e., reading one word at a time with each eye fixation and vocalizing words as they are read.
6. c. Therefore, in this Exercise, The Reader's Edge teaches:
1) The limitations of individuals who are ORAL (inefficient) readers—their reading speed is limited to the rate at which they can speak—about 160 to 200 words per minute (WPM)
2) That SILENT, i.e., Efficient Readers can read 3 to 5 times faster
7. d. Those Efficient Readers have improved comprehension, retention and recall.
d. 3. User will learn, & gain confidence in 50% of the Efficient Reading process, i.e., to
e. 4. understand:
8. a. The limitations of ORAL reading, i.e., to the rate at which they speak.
9. b. That with SILENT reading skills, in single eye fixations, they can see, read & process more than one word at a time, 3 to 5 times faster than with ORAL reading skills.

### 6. Visual Exercises—Vertical Span

f. 1. Two Word to Eight Word Phrases at User-controlled rates, including Prime

Words in OUT OF SEQUENCE groups of words, and including phrases composed of Prime Words IN SEQUENCE. FIGS. 7 and 8 illustrate screens which appear during this exercise.
10. a. Phrases are composed of The Literacy Company's Prime Words which are:
1) Immediately recognizable
2) Do not need decoding and
3) The eye does not fixate on them
11. b. User chooses Yes or No re confirmation.
g. 2. Vertical Span Goal
12. a. Pursuant to the best pedagogical methodology, it is important for a student to gain confidence that they have the ability to learn whatever is being taught
13. b. TLC wants to teach how to:
1) Unlearn the habit of inefficient readers, i.e., reading one word at a time with each eye fixation and vocalizing words as they are read.
2) Learn the habits & skills of efficient readers, i.e., reading more than one word at a time with each eye fixation and not vocalizing words as they are read.
14. c. Improves horizontal & vertical eye span & decreases the tendency to vocalize.
15. d. Two to Eight Word Phrases are displayed:
1) OUT OF SEQUENCE: Users see, read and process the words in a single eye fixation & then re-assemble them into a meaningful unit of meaning—vocalization is reduced.
2) The Out of Sequence presentation helps memory and reduces the tendency to vocalize
3) IN SEQUENCE, representing a single unit of meaning, confirming the User's ability to see groups of words in a single eye fixation.

### 7. Visual Exercises—Marquee Text

h. 1. User chooses Reading Selection by
16. a. Area of interest
17. b. Reading level
i. 2. Displays Text, from a complete narrative, scrolling:
18. a. Horizontally
19. b. Vertically
20. c. At a User controlled rate
j. 3. Marquee Text Goal
21. a. Expands horizontal and vertical eye span
22. b. Forces User to read groups of words with single eye fixations, while minimizing the tendency to vocalize words as they are read.
k. 4. FIG. 9 illustrates a screen which appears during the Marquee Text exercise and uses text which scrolls along a horizontal line.
l. 5. FIG. 10 illustrates a screen which appears during the Marquee Text exercise and uses text which scrolls vertically from line to line.

### 8. Visual Exercises—Highlight Text

m. 1. User Chooses Reading Selection by
23. a. Area of interest
24. b. Reading level
n. 2. Display Text, from a complete narrative, with the ability to highlight words, and with User controlling the number of words, using:
25. a. Underlining
26. b. Highlighting
o. 3. Goal
27. a. Reduce the number of eye fixations
28. b. Expand the number of words the eyes see with each eye fixation, or glance of the eye.
p. 4. FIG. 11 illustrates a screen which appears during the exercise.

### 9. Visual Exercises—Word Groups

q. 1. a User chooses Reading Selection by:
29. a. Area of interest.
30. b. Reading level.
r. 2. Text from a complete narrative is displayed in groups of words. Each group includes:
31. a. One to four lines.
32. b. Up to four words per line.
s. 3. One or more groups of words is shown on each page or display FIG. 12 illustrates one group, or“clump” of words on a page. FIG. 13 illustrates seven groups, or “clumps” of words on a page.
t. 4. The length of time that each page is displayed is adjusted by a user.
u. 5. The Word Group Exercise:
33. a. Reduces and then eliminates vocalization.
34. b. Expands horizontal and vertical eye spans of recognition.
35. c. Guides users to see, read and process in a single eye fixation without vocalizing more than one word at a time, i.e., to see in a single eye fixation groups of words or units of meaning.

### 10. Visual Exercises—Continuous Text

v. 1. A User Chooses a Reading Selection by
36. a. Area of interest.
37. b. Reading level.
38. c. Columns.
39. d. Use of a Pacer to guide the eye.
w. 2. The Reading Selection Comprises Text form a complete portion (i.e., a paragraph, page, chapter, etc.) of a narrative.
x. 3. The User Select an Eye Pacer Which Moves Along the Page and
40. a. Is Displayed on Each Page or Display as a Pencil, Pen, Hand or Bar. FIGURE DISPLAY 14 illustrates the finger of a hand (positioned beneath and to the right f the word “became” in the first or left hand column) used as a pacer.
41. b. Is Positioned Left, Center or Right of Text.
42. c. Moves Digitally, Analog or Manually.
43. d. Is Gradually Minimized until it is not Needed.
y. 4. Questions to Test Comprehension are generated by the Program in the form of:
44. a. True/False Questions.
45. b. Multiple Choice Questions.
46. c. CLOZE. Users “fill in the blank” and enter missing word(s) in a sentence. CLOZE is preferred because it makes it difficult for a user to guess at the correct answer.

### 11. Visual Exercises-Push Down-Push Up Text

z. 1. A User chooses a Reading Selection by Area of interest and Reading Level. The reading selection comprises a complete portion of a narrative.
aa. 2. In PUSH DOWN, the User reads as far as he or she can in 60 seconds, and to mark the spot reached in 60 seconds by clicking on the last line reached, which highlights it. The User then rereads the same text in 50 seconds and attempts to read further than he or she did in 60 seconds. The User the rereads the same text in 40 and 30 seconds and each time attempts to read further than he or she did in previous readings of the text. If desired, during the exercise the program can automatically reset the time from 60 to 50 to 40 to 30 seconds.
47. a. In PUSH UP, the User reads as far as he or she can in 60 seconds and then marks the spot by clicking on the last line reached, which highlights it.
48. b. The User then adds additional text equivalent to 5 to 50% of the text read during the first 60 seconds and in 50 seconds attempts to read the text that was read in 60 seconds PLUS the additional amount of text (i.e., the 5 to 50%) the User chose to add.
49. c. The User then adds additional text equivalent to 5 to 50% of the text read during the first 60 seconds and in 40 second attempts to read the text that was read in 60 seconds PLUS the additional amount of text the User chose to add.
50. d. The User then adds additional text equivalent to 5 to 50% of the text read during the first 60 seconds and in 30 seconds attempts to read the text that was read in 60 second PLUS the additional amount of text the User chose to add.
bb. 3. The Push down-Push Up Exercise demonstrates the benefit of familiarity with the reading selection.

### 12. Visual Exercises—High Speed Practice

cc. 1. A User chooses Reading Selection by Area of interest and Reading level. The reading selection comprises a complete portion (i.e., a page, paragraph, chapter, etc.) Of a narrative (i.e., of a book, magazine article, etc.)
dd. 2. The Text is displayed with the Topic sentence in each paragraph bolded. See FIG. 17.
ee. 3. The Reading Rate is Initially Set at 50,000 Words per Minute (WPM), but is adjustable down to 100 WPM.
ff. 4. The User attempts to Read the Bolded topic Sentences at 50,000 Words per Minute, which normally is not possible. The User Gradually reduces the WPM to less than 5,000 WPM, so the User can see, read and process the Topic Sentences. Pre or Post-Reading the Topic Sentences familiarizes a User with the Content of the Reading Selection.

### 13. Oral & Visual Exercises—Say it

gg. 1. A User chooses Reading Selection by Area of interest and Reading level.
hh. 2. The User Enters or Selects or Highlights, and the Speech Engine audibly pronounces:
51. a. Letters
52. b. Words
53. c. Numbers
ii. 3. The Goal of the Say It Exercises is to Teach Users (even functionally illiterate Users)
54. a. What the Letters, Words or Numbers LOOK like and SOUND like.
55. b. This Exercise assists Users in improving their word association skills by familiarizing them with the sounds associated with Letters, Words and Numbers.

### 14. Oral & Visual Exercises—Audio Readings

jj. 1. A User chooses Reading Selection by Area of interest and Reading level. The text comprising the Reading Selection is shown in the manner illustrated in FIG. 19.
kk. 2. The User clicks on “Words” to produce the drop down menu shown in FIG. 19 and clicks on the appropriate selection in the menu to cause the Speech Engine to read audibly:
56. a. Words one-by-one
57. b. Sentences word-by-word
58. c. Paragraphs word-by-word
59. d. Entire sentences
60. e. Entire paragraphs
ll. 3. This Exercise teaches User (even functionally illiterate users)
61. a. What the letters, Words or numbers LOOK like and SOUND Like.
62. b. To improve their word association skills by familiarizing them with the:
1) Individual sounds associated with Letters, Words and Numbers.
2) Correct sounds of words, sentences and paragraphs read at normal speaking rates.

### 15. Comprehension Test Questions

mm. 1. A User chooses a Reading Selection by Area of interest and Reading level. The text is displayed in the manner illustrated in FIG. 20.
nn. 2. The pedagogical hierarchy of comprehension questions is:
63. a. True/False questions give a user a 50/50 chance of giving the right answer by guessing.
64. b. Multiple Choice questions also give a user a chance of getting the right answer by guessing, but also may have tow or more “correct” answers.
65. c. Cloze provides the most reliable way of testing comprehension because a User must “fill-in the blanks” with the right words. A cloze comprehension test is illustrated at the bottom of FIG. 20.
oo. 3. The Reader's Edge program can dynamically, on the fly, create a series of Cloze-type questions from any (digital) reading selection chosen by the User, either form the Program, or imported by the user from any source.

### 16. RSS Feeds

pp. 1. User chooses, from any digital source of reading material, a Reading Selections by area of interest and Reading level.
qq. 2. The Reader's Edge permits accessing RSS feeds and importing text into The Reader's Edge Exercises.

Having described my invention in such terms as to enable those skilled in the art to make and use the invention, and having described embodiments thereof, I claim:

1. A system to improve reading skills in preparation for taking a standardized test, comprising
(a) a system to identify the most frequently utilized prime words in a language;
(b) a house;
(c) a computer mounted in said housing;
(d) a display operatively associated with said computer;
(e) a computer program product in a storage medium readable by said computer, said product comprising program code for preparatory reading exercises shown on said display and
(i) utilizing vocabulary including selected ones of said most frequently utilized prime words, and
(ii) displaying on said display said most frequently used prime words in formats requiring reading two or more of said most frequently used prime words simultaneously in a single eye fixation.

2. A system to improve reading skills in preparation for taking a standardized test, comprising
(a) a system to identify the most frequently utilized prime words in a language;
(b) a system to identify supplemental relevant standardized test-related words in said language;
(c) a housing;
(d) a computer mounted in said housing;
(e) a display operatively associated with said computer;
(f) a computer program product in a storage medium readable by said computer, said product comprising program code for preparatory reading exercises shown on said display and
(i) utilizing a master vocabulary list including at least
100 of said most frequently used prime words, and
100 standardized test-related words each different from each of said 100 most frequently used prime words, and
(ii) displaying on said display said most frequently used prime words and said standardized test-related words in formats requiring reading two or more words simultaneously in a single eye fixation.

3. A system to improve the reading skills of an individual in preparation for taking a standardized test, comprising
(a) a system to identify the most frequently utilized prime words in a language;
(b) a system to identify supplemental relevant standardized test-related words in a language;
(c) a system to digitize said supplemental relevant standardized test-related words in a first storage medium readable by a computer;
(d) a housing;
(e) a computer mounted in said housing;
(f) a display operatively associated with said computer;
(g) a computer program product in a second storage medium readable by said computer, said product comprising program code for
(i) producing preparatory reading exercise shown on said display,
(ii) importing from said first storage medium said supplemental relevant standardized test-related words,
(iii) utilizing vocabulary including at least
100 of said most frequently utilized prime words, and
100 of said standardized test-related words each different from each of said 100 of said most frequently used prime words,
(iv) displaying said most frequently used prime words and said standardized test-related words in formats requirement reading two or more words in a single eye fixation.
